(19) United States
(12) Patent Application Publication
(10) Pub. No.: US 2015/0262306 A1
(43) Pub. Date: Sep. 17, 2015

(54) COMPUTER-BASED SYSTEM AND METHOD FOR PORTFOLIO OPTIMIZATION

(71) Applicant: Efficient Tax LLC, Anchorage, AK (US)

(72) Inventor: David Richard Gottstein, Anchorage, AK (US)

(21) Appl. No.: 14/514,368

(22) Filed: Oct. 14, 2014

Related U.S. Application Data
(60) Provisional application No. 61/890,097, filed on Oct. 11, 2013.

(51) Int. Cl. G06Q 40/06; G06Q 40/00

(52) U.S. Cl. CPC G06Q 40/06; G06Q 40/10

(57) ABSTRACT

A computerized system, computer-implemented method, and/or computer-readable medium for analyzing of a portfolio of tax-lots to facilitate maximization or optimization of after-tax wealth over a specified time horizon, by determining a sequence for selling of individual tax-lots, across an entire portfolio of taxable equity security tax-lots in a manner that achieves the maximization or optimization of after-tax wealth over a specified time horizon, by performing processing to identify the (i) selling first those tax-lots, in descending sequence, that by doing so would generate the greatest excess after-tax returns, or alpha, and (ii) then, if additional sales are desired, selling in a manner that gives up the least opportunity cost of doing so by selling first, in ascending order, those tax-lots with the least after-tax return potential remaining.

### RELATED APPLICATIONS

This application claims the benefit of U.S. Provisional Application No. 61/890,097, filed Oct. 11, 2013, which is hereby incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

The present disclosure relates generally to the processing of financial securities and instruments and, more particularly, in some embodiments, to a computer-based system and method, as well as to at least one computer-readable medium, for facilitating optimization of a portfolio of tax-lots by determining and recommending the best sequence and combination of tax-lots to sell.

Generally, the American financial services industry has not introduced any major improvements in the management of taxable equity portfolios for over two decades. It still relies largely on the goals and metrics of success offered by the traditional tax efficiency approach of minimizing taxes in a year. While the present inventor has previously developed and patented a computerized system and method that does not apply such a traditional tax efficiency approach and that optimizes after-tax proceeds for individual tax lots, accurately determining the after-tax value an individual could expect to have at the end of a holding period for each of a set of investment strategies associated with a particular lot of stock held (representing a major improvement in taxable equity management), there remains a need for further improvements in portfolio management.

### BRIEF DESCRIPTION OF THE DRAWINGS

Aspects, features, and advantages of some embodiments of the invention, both as to structure and operation, will be understood and will become more readily apparent in view of the following description of non limiting and non exclusive embodiments in conjunction with the accompanying drawings, in which like reference numerals designate the same or similar parts throughout the various figures, and wherein:

FIG. 1 depicts an illustrative computer based Efficient Tax Portfolio Optimization system and method according to some embodiments of the present disclosure; and

FIGS. 2A, 2B, 3A, 3B, 4A, 4B1, 4B2, 5A, 5B1, and 5B2 depict illustrative example screenshots of a front-end user interface associated with an Efficient Tax Portfolio Optimization system and method according to some embodiments of the present disclosure.

### DETAILED DESCRIPTION OF SOME ILLUSTRATIVE EMBODIMENTS

Throughout the description and claims, the following terms take at least the meanings explicitly associated herein, unless the context dictates otherwise. The meanings identified below do not necessarily limit the terms, but merely provide illustrative examples for the terms. The phrase “an embodiment” as used herein does not necessarily refer to the same embodiment, though it may. In addition, the meaning of “a,” “an,” and “the” include plural references; thus, for example, “an embodiment” is not limited to a single embodiment but refers to one or more embodiments. Similarly, the phrase “one embodiment” does not necessarily refer the same embodiment and is not limited to a single embodiment. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, as used herein, unless the context clearly dictates otherwise, the term “coupled” refers to directly connected or to indirectly connected through one or more intermediate components

Some embodiments of the present invention relate to what is referred to herein as the Efficient Tax Portfolio Optimizer (ETPO), which may be embodied as a computerized system, computer-implemented method, and/or computer-readable medium. However embodied, ETPO represents and/or provides, among other things and in some respects, a complex set of structured computer-implemented mathematical calculations according to methods that empower investment decision makers to harmonize and synergize the selling of individual tax-lots, in a sequence, across an entire portfolio of taxable equity security tax-lots, doing so in a manner that achieves the maximization or optimization of after-tax wealth over a specified time horizon. And, as will be further understood from the ensuing disclosure, ETPO provides for such maximization or optimization by principally, but not limited to, identifying, recommending, and/or simulating a combination of (i) selling first those tax-lots, in descending sequence, that by doing so would generate the greatest excess after-tax returns, or alpha, (i.e., recommending (i) first selling the tax-lot whose sale would generate the greatest after-tax return, or alpha and (ii) next selling the tax-lot whose sale would generate the greatest after-tax return, assuming the first-recommended tax-lot with the greatest alpha were sold, etc., until none of the remaining or residual tax lots provide positive alpha, and (ii) then, if additional sales are desired, selling in a manner that gives up the least opportunity cost of doing so by selling first, in ascending order, those tax-lots with the least after-tax return potential remaining (i.e., recommending (i) first selling the tax-lot with the least after-tax return potential remaining, and (ii) next selling the tax-lot with the least after-tax return potential remaining, assuming the first-recommended tax-lot with the least after-tax return potential remaining were sold, etc., for all remaining tax-lots under consideration).

In accordance with some embodiments, tax-lot analysis providing resulting values representing, among other metrics, the after-tax return, or alpha, and the after-tax return potential upon which some embodiments of the present invention are based is disclosed in the present inventor's U.S. Pat. No. 6,115,697, U.S. Pat. No. 7,047,217, and U.S. Pat. No. 7,343,336 (“the prior patents”), each of which is hereby incorporated by reference herein in its entirety. As disclosed in detail in the prior patents, such output values are based upon expected after-tax returns resulting from comparing current tax-lot after-tax values against future expected after-tax values, considerate of expectations such as price target projections or forecasts over time. The aforementioned resulting values from the prior patents include the “After-Tax Annual Average Recommendation Advantage” (ATAAR) and the “Existing Tax-Lot After-Tax IRR” (ETLATIRR).

In accordance with some embodiments, the Existing Tax-Lot After-Tax IRR is the calculated compound after-tax Internal Rate of Return (IRR) amount generated by comparing the current after-tax value of an owned individual tax-lot (assuming any imbedded and deferred tax liability were to be paid) with the forecasted net after-tax value of the tax-lot given its future price projection at the end of a chosen investment horizon, along with all other material economic impacts accounted for, such as dividends, and investment costs. The ETLATIRR may be determined as an annual compounding rate, and may be represented as a percentage. By way of example, if the current after-tax value of an existing owned tax lot is $80, and the 3-year (36 month) forecasted net after-tax value of this tax lot is $100, then the ETLATIRR for this tax-lot would be 7.72% (i.e., 100[(100/80)^{1/3}−1)]).

In accordance with some embodiments, After-Tax Annual Average Recommendation Advantage corresponds to so-called Alpha, and represents the advantage that would result from following a recommended investment strategy with respect to a tax-lot (e.g., sell now and reinvest; or sell and reinvest when longterm status is reached) rather than holding the tax lot until the end of the chosen investment horizon. In some embodiments, the After-Tax Annual Recommendation Advantage is set forth as a percentage. For clarity, the name of this metric references what it represents. For instance, it is presented on an After-Tax basis. And it is an “Annual Average” because it specifies the result (percentage advantage) that the investor would achieve on an annual basis, however, it is not an Internal Rate of Return calculation (i.e., it is not a calculation of an average annual compound rate). Rather, it is a simple average of the advantage through the end of the chosen investment horizon; namely, that advantage divided by the number of years until the end of the chosen investment horizon.

For example, if an investor is projected to have $100 after-tax should they hold a tax-lot for three more years, but would achieve a value at the end of three years of $110 if they waited until the tax-lot were to be held more than 365 days in total (i.e., to achieve long-term tax rate) to sell it and reinvest, the extra $10 of the latter strategy (Sell When Long-Term) versus the Hold $100 comparative value would yield the investor an extra 10% in after-tax wealth accumulation over three years. Dividing the 10% by three years provides a simple annual average of 3.33%, which is the After-Tax Annual Average Recommendation Advantage for this example. That is, according to this example, a $110 after-tax value forecasted to be attained by waiting until the long-term lower tax rate status is achieved before selling and reinvesting, as compared with a hold value of $100, would yield a 10% Alpha, excess return, or an After-Tax Annual Average Recommendation Advantage of 3.333% per year over a three year horizon. In accordance with such embodiments of the ATAARA, a more traditional IRR or compound value is not calculated because the extra value is often not achieved unless the Sell When Long-Term Maximum Strategy is followed, and that deferral makes a traditional IRR calculation problematic.

And finally, the term “Recommendation Advantage” in ATAARA refers to the fact that the Maximum Strategy Recommendation must be followed in order to capture any projected excess return. And, more simply, the term “Recommendation Advantage” refers to the ATAARA being the advantage associated with following the Maximum Strategy Recommendation (other than Holding). If there is no excess return by doing something other than Holding, the ATAARA value will be zero. Said differently, if Holding (to the end of the chosen investment horizon) is the Maximum Strategy Recommendation, then the ATAARA is zero, which is consistent with the Holding strategy after-tax value being the reference against which alpha is measured. In other words, the ATAARA is by definition set to zero if at the end of the chosen investment horizon, Holding would provide a greater after-tax value than any strategy other than holding. And ATAARA is by definition—and by calculation—equal to zero if at the end of the chosen investment horizon, Holding would provide an after-tax value equal to the greatest after-tax value that would be provided by the strategies other than holding.

And, more specifically, the Maximum Strategy Recommendation (also referred to as the “Max Strategy” or the like) is the strategy determined to provide the highest after-tax value from among the potential strategies evaluated. In accordance with some embodiments, an investor principally has three choices they can make that can make a material difference in the long-term after-tax wealth accumulation related to existing capital deployed in an existing tax-lot invested. These choices are the following: (1) Hold the subject tax-lot out to the end of a chosen investment horizon before selling and reinvesting; (2) Sell When Long-Term in the case of a tax-lot held less than the Long-Term tax status term (i.e., one year according to current tax law relating to Capital Gains), and then reinvest the after-tax proceeds, (i.e., wait until Long-Term tax status is achieved before selling and reinvesting); and (3) Sell Now and reinvest. For each tax-lot analyzed, the Max Strategy (Maximum Strategy Recommendation) is the identified highest after-tax strategy value from among these three potential strategies.

As indicated above, and as will be further understood in view of the ensuing disclosure, ETPO according to some embodiments is not driven by reducing, minimizing, deferring, or avoiding taxes, but by maximizing or optimizing the after-tax value of a portfolio by, among other things, determining with respect to each tax lot in a portfolio (or with respect to a subset of multiple tax lots selected by a user from among all the tax lots within the portfolio) what investment strategy to employ—and in what sequence respective tax lot strategies recommending a sale (e.g., Sell Now, Sell When LongTerm) should be executed, as well as in what sequence tax lots recommended to be held should be sold should the investor decide to sell them (e.g., to raise cash)—to provide the greatest after-tax value over a selected investment horizon, considering the effects of selling a given tax lot on all other remaining or residual tax lots.

More specifically, as will be further understood, ETPO applies its fundamental sell discipline over entire portfolios of tax lots, considering (among other things) the impact of each recommended potential tax lot sale on the potential strategy paths of the remaining or residual tax lots, such that ETPO indications or recommendations output by ETPO inform the user of the best sequence and combination of tax-lots to sell for trying to raise cash, and/or for improved portfolio repositioning. While ETPO's goal is not tax avoidance or minimization per se, ETPO can materially enhance after-tax performance over time. By generating a rigorous after-tax sell disciplined ranking of tax-lots to be sold in a sequence across an entire portfolio, ETPO can result in taxes being minimized—but not at the expense of future after-tax returns. In accordance with some embodiments, the recommendation provided by ETPO is (i) to first sell whole or partial tax-lots that when sold, are forecasted to generate the greatest After-Tax Alpha, and (ii) secondly, to sell any remaining tax-lots in the sequence recommended by the ETPO which results in keeping those tax-lots with the greatest after-tax return potential remaining

For clarity of exposition of an ETPO according to the present disclosure, the ensuing disclosure includes the following sections: (i) a description of some features of the prior patents; (ii) a description of the dependency, or nexus between the present disclosure and prior patents; (iii) a further description of computer-based methods and systems according to some ETPO embodiments of the present disclosure, and (iv) detailed examples described with reference to illustrative screenshots from a reduction to practice of some embodiments of an ETPO according to the present disclosure.

Some Features of the Prior Patents

To aid the process of describing some embodiments of the present invention, the following paragraph reproduces a portion of the description set forth in the original one of the prior patents. Then, set forth in concise terms are some aspects of some features that the prior patents disclose and provide, as well as some features that the present inventor recognized can be used and derived therefrom in accordance with the present disclosure, and how therefore certain aspects and features of the prior parents are linked to and embodied in some embodiments of the present invention.

Particularly, a portion of the prior patent reads as follows: “A computerized system and method process financial securities and instruments to accurately determine and optimize the after-tax proceeds an investor could expect to have at the end of a holding period for each of a set of investment strategies and determines an optimal strategy for maximizing such after-tax proceeds. The computerized system and method receive tax and investment data, user-customized investment expectations, and financial adviser-based investment expectations at a processor; perform tax loss harvesting analysis on the user-customized investment expectations and the financial adviser-based investment expectations over a dynamic taxation time range using a predetermined software program; perform comparative pro-forma tax sensitivity analysis of the tax and investment data and the analyzed investment expectations using the predetermined software program; and determine and output an optimal after-tax investment strategy path from a plurality of investment strategy paths over the dynamic taxation time range using the predetermined software program to optimize the after-tax proceeds from the plurality of investment strategies. The predetermined software program may include a spreadsheet program.”

What that means is that the prior patents disclose (among other things) comparing after-tax results (e.g., down to the penny in some implementations) of the material investment choices an investor has in deciding when to sell a taxable investment, pay any associated tax, and reinvest for higher projected after-tax returns. Performing such a comparison facilitates identifying the metric circumstances in which a holder of an individual, or group of tax-lots, would be better off on an after-tax basis, over time, by selling and reinvesting, and by how much better an alternative investment would have to be in order to more than pay for any costs associated with selling a taxable security, including the tax liability. Such comparisons and resulting information are a function or mathematical result of a set of investment facts and performance expectations supplied by the user.

Specifically, the choices, if a capital asset has been held less than 366 days, therefore not qualifying for long-term lower tax rates, are (i) holding a stock out to the end of a specified time horizon, selling and paying any tax due, (ii) selling the investment now, paying any taxes and associated costs, and reinvesting out to the end of the same time horizon, and (iii) waiting until the long-term tax status is achieved, before selling and reinvesting out to the end of the same investment horizon. Whichever strategy path yields the greatest after-tax value is identified in accordance with the methods and systems of the prior patents. For a capital asset (e.g., tax-lot of a security) for which the long-term status is already achieved, the same analysis is done, but without analyzing the third option of waiting until the long-term window is achieved before selling and reinvesting, as it already has been eclipsed.

Included as inputs are things known to the user (e.g., investor, portfolio manager, etc.), such as what was purchased, the price paid, and current realized gain and loss values, along with things that a user thinks (e.g., believes or expects, based on personal knowledge and/or opinions, as well as possible reference to the user's or third party's proprietary algorithms and/or research, etc.), like the future performance expectations for holding a position, including dividend and dividend growth, as well as reinvestment assumptions. The present inventor could have expressly added into the particular disclosed embodiments a strategy path for selling on any day until the long-term horizon would be achieved, but only included in those illustrative embodiments the strategy paths that generally represent material or meaningful change in the economics.

So by way of example, given various inputs, holding an individual tax-lot investment (an amount of shares purchased on a particular day at a particular price, or cost basis rather) having a current after-tax value of $80, might be forecasted to yield an investor $100 after-tax at the end of a three year investment horizon. Alternatively, according to methods and systems disclosed in the prior patents, this investment might be forecasted to provide (i) $105 after-tax if it were sold and reinvested now, and (ii) $110 after-tax if it were sold and after-tax proceeds reinvested once it achieved long-term status. In this example, the highest after-tax value result is, of course, to wait until the long-term tax status is achieved before the tax-lot is to be sold, and any after-tax proceeds reinvested.

From these values, along with other calculations based on the disclosure of the prior patents, the following mathematical results, plus others not listed here, are able to be determined, predominately because of the horizon after-tax strategy path values being calculated:
1. The current after-tax value of an individual tax lot, calculating a value assuming the subject tax-lot were to be sold today, and taxes paid. This value is used in the calculation of the Existing Tax-Lot After-Tax IRR value, which, as described above, is a comparison of an individual tax-lot's current after-tax value and its forecasted prospective after-tax value. And, more particularly according to some embodiments, the ETLATIRR is the percentage annual compound rate of return that the existing after-tax value of a tax-lot must grow in order to achieve the prospective after-tax value.
2. The forecasted prospective after-tax value of net proceeds, at the end of a chosen time horizon, should a position be held until the end of a chosen time horizon and then sold, with the resulting economic impacts, tax and otherwise. As may be understood, this value is the Hold Strategy Path end-of-horizon after-tax value.
3. The forecasted prospective after-tax value of net proceeds should a subject tax-lot be sold, with any taxes and or commissions being paid, with their net proceeds reinvested out to the end of the same time horizon. As may be understood, this value is the Sell Now & Reinvest strategy path resulting value.
4. The forecasted prospective after-tax value of net proceeds should an investor defer selling the subject tax-lot until the long-term tax status is achieved, before selling and reinvesting, when appropriate. As may be understood, this value is the Sell When Long-Term strategy path value (which is related to accompanying values associated with its calculation).
5. Alpha, or the excess after-tax improvement on returns comparing the difference between the end of horizon after-tax value of holding a position, versus the greater of selling now, or waiting until the long-term status, if appropriate (i.e., if long-term status has not already been achieved). This value corresponds to the “After-tax Annual Average Recommendation Advantage,” which is also further described hereinabove. The ATAARA is the difference between the end-of-horizon after-tax value of the end-of-horizon highest value strategy path, if it is higher than the Hold Position after-tax proceeds end-of-horizon value, and the Hold end-of-horizon after-tax proceeds value, with this difference divided by the Hold end of horizon after-tax value, and further divided by the number of years in a horizon (or, equivalently, it is the end-of-horizon value of the end-of-horizon highest value strategy path, if it is higher than the Hold Position after-tax proceeds value, divided by the Hold end-of-horizon after-tax proceeds value, with one subtracted from this ratio, and the resulting quantity divided by the number of years in a horizon). That advantage is zero if holding the position offers the greatest forecasted after-tax value. This After-Tax Annual Average Recommendation Advantage output value, derived from the methods and systems of the prior patents, is a primary input into the portfolio optimization process provided by ETPO according to some embodiments of the present disclosure.
6. The tax liability associated with selling the tax-lot now. That number will be different depending upon whether the tax-lot has been held more than 365 days or not, and a function of the investor's tax rates, and tax-lot cost basis.
7. The Internal Rate of Investment Return, over the chosen time horizon, of comparing the current after-tax value of a tax-lot, against its prospective after-tax value of holding an individual tax-lot. This value is referred to as the “Existing Tax-Lot After-Tax IRR,” and is further described hereinabove. This out-put value, derived from prior patented mathematics, derived from the methods and systems of the prior patents, is also a primary input into the portfolio optimization process provided by ETPO according to some embodiments of the present disclosure.
8. In a first step in a Tax-Loss Harvesting process, in deciding whether it might be optimal to sell a security with a loss, what may be calculated (in accordance with methods and systems of the prior patents) is when the combination of (1) the after-tax value that a currently unrealized loss could capture in the form of tax savings if it were harvested against another profitable tax-lot, if sold, when added to (2)the difference in after-tax return potential between the Existing Tax-Lot After-Tax IRR, and the after-tax return potential of an alternative investment, assuming a net proceeds reinvestment rate of return assumption, (capable of being a positive or a negative), would generate a higher after-tax value at the end of a chosen investment horizon.
9. And finally, in a second step of a Tax Loss Harvesting process, what may be calculated (in accordance with methods and systems of the prior patents) is when offsetting an existing realized loss, against a number of shares of an existing profitable tax-lot, given its Existing Tax-Lot After-Tax IRR at its current price, would yield a higher value in after-tax proceeds at the end of a chosen investment horizon, than holding that number of shares out to the end of a chosen investment horizon, if that number of shares would be sold and its after-tax proceeds reinvested.

Based on these outputs, important further outputs for analysis purposes at the individual tax-lot level, which have always been primary outputs of the methods and systems of the prior patents, may be calculated and determined.

Illustrative Nexus between the Prior Patents and Some ETPO Embodiments

And, as has already been stated, such outputs are employed as primary calculation and decision driver inputs in the portfolio optimization methods and systems as implemented by some embodiments of ETPO according to some embodiments of the present disclosure. For instance, as indicated, outputs disclosed in the prior patents that are employed as primary metrics in some ETPO embodiments of the present disclosure include the After-Tax Annual Average Recommendation Advantage value and the Existing Tax-Lot After-Tax IRR. In other words, some embodiments of methods and systems according to the present invention are directly dependent upon the calculation results of the methods, algorithms, and outputs of the prior patents. The ensuing description further elaborates methods and systems according to some embodiments of the present invention, relating to what is referred to herein as the Efficient Tax Portfolio Optimizer (ETPO).

Elements and Methods of Some Embodiments of the Present Disclosure

The following sets for the some illustrative goals of some embodiments of ETPO. As will be understood, one or more claims may be directed to methods and systems for providing each of these goals and/or methods and systems comprising combinations of features embodied in ETPO corresponding to these goals. Illustrative goals include, for example, the following:

1. Over Arching Goal: Through computer simulation, guide the investor, based upon fundamental investment and mathematical calculations, when it might be appropriate to sell versus hold one or more tax-lots in a position, and or one or more tax-lots within a portfolio, and in what sequence, in order to maximize the capture of future more opportunistic excess returns, or Alpha, in order to maximize after-tax wealth over various investment time horizons, considerate of U.S. tax laws, an investor's investment facts they input, and what expectations of future investment performance they choose and input.

Based upon these and other chosen inputs, some embodiments of ETPO will identify for an investor, which tax-lots, either individually, or in combination with others, for example ones with unrealized gains and ones with unrealized losses, and in which sequence, if an investor were to sell and reinvest the net after-tax proceeds, they could achieve greater after-tax wealth over time, and how much an investor could expect to achieve on an after-tax wealth accumulation basis, if the assumptions inputted are good predictors of future performance. And doing so in a manner that generates the greatest Alpha or excess return at the tax-lot and portfolio level, by identifying when, for example in the case of a profitable tax-lot, the relative extra performance potential of an alternative investment versus that remaining from an existing tax-lot, will generate greater after-tax proceeds over a designated time period, because the new investment is forecasted to outperform an existing investment by more than the amount of the tax. And harmonizing and synergizing that process, by updating the realized gain and loss values with the simulated impacts of previously sold tax-lots within a sequence, (an important part of the ETPO methods as those updated realized gain and loss values are important inputs), resulting in the maximizing of the multi-year after-tax wealth accumulation of an investor, through the integration of the individual tax-lot sell discipline applied across an entire portfolio in a way that minimizes taxes, but not at the expense of future after-tax wealth accumulation. And doing so in a manner that keeps the higher forecasted after-tax return potential tax-lots in a portfolio, in order to maximize its future after-tax returns. This reiterative process, when applied to an entire portfolio, is referred to as an optimization “Serial Stream.”

2. Supporting Goal: Apply a maximizing after-tax wealth strategy at the individual tax-lot level, and within that framework, calculate for the user, in which sequence to sell all or part of tax-lots in order to sell tax-lots first that generate the greatest After-Tax Annual Average Recommendation Advantage, and then when wanting to raise additional cash, recommending a sequence of tax-lot selling that sells those tax-lots first with the least Existing Tax-Lot After-Tax IRR. This prejudices a portfolio in retaining those tax-lots that have the greatest return potential remaining, on an after-tax basis.

3. Supporting Goal: Generate the realizing of gains and losses at the tax-lot, and partial tax-lot level that, across entire portfolios, considerate of future performance expectations, in a manner that realizes losses when there is greater after-tax wealth generation forecasted when both its future performance forecasted, and any after-tax proceeds, including a reduction in taxes needed to be paid on another profitable tax-lot, can be reinvested in order to achieve higher after-tax results than by continuing to hold, and those losses are applied first against profitable tax-lots that offer the greatest After-Tax Annual Average Recommendation Advantage, or Excess Return, when sold, or have the least after-tax return potential remaining, based upon forecasts.

A component of the simulation methods used in the optimization process is to continuously update the projected realized gain and loss values for the investor, impacted by a potential prospective sale or partial sale of tax-lots in a specified sequence, to be used in the determination of additional full or partial tax-lot sales, through the process of Tax Loss Harvesting. In accordance with the illustrative method according to some embodiments of the present invention, being able to run an analysis with one iteration of processing across a portfolio of tax-lots calculating values for the After-Tax Annual Average Recommendation Advantage and the Existing Tax-Lot After-Tax IRR, the key drivers of the sell decision sequencing process, is not sufficient for the Efficient Tax Portfolio Optimizer methods. When all tax-lots for example, are evaluated for which one, if it were sold, would generate the highest After-Tax Annual Average Recommendation Advantage, any subsequent analysis for which tax-lot should be sold next, is dependent upon the resulting values for Realized Gain & Losses from any tax-lot simulated to be sold precedent to it. Therefore in accordance with methods and systems according to some embodiments of the present invention, by way of example, a ten tax-lot portfolio, at a minimum, will have to have all ten tax-lots evaluated and compared in order to determine the most value-added tax-lot to sell first. Once that has been identified, the remaining tax-lots, with an updated realized gain and loss value, will have to be evaluated, in order to identify the best of that group of tax-lots to sell, or rather the second tax-lot in sequence to sell. Then the remaining eight tax-lots will have to be evaluated and compared (with the further updated realized gain and loss value), with the same process repeated until through a process of elimination, all tax-lots, or partial tax-lots have been evaluated and compared for a sale.

4. Supporting Goal: Allow the user to Designate, independent from an ETPO portfolio optimizing decision process, how many shares of an individual tax-lot they wish to sell. There are other reasons to sell or reduce a position than just for valuation purposes, like having too much of an individual stock. This is important in the optimization process, since the realized gain and loss values are important inputs into the Efficient Tax algorithms. Designating individual tax-lots to be sold, in whole or in part, affects an investor's realized gain and loss values. Therefore, accounting for the impacts of these separate Designated decisions on any realized gain or loss values, allows the investor to start an optimization process with accurate projected realized gain and loss values to be incorporated into the ETPO.

5. Supporting Goal: In addition, a desired (i.e., investor-designated) reduction in an investment position, that is an assembly of more than one tax-lot, should be done in a sequence, similar to numbers 1 and 2 described just above. For instance, if an investor has 1,000 shares of a company, and that position is made up of a dozen tax-lots, ETPO will guide the investor to sell those individual tax-lots, considerate of any prior individual tax-lot sell decision Designations, in sequence, selling those tax-lots first that generate the greatest After-Tax Annual Average Recommendation Advantage, if any exist, and then those that have the least Existing Tax-Lot After-Tax IRR remaining

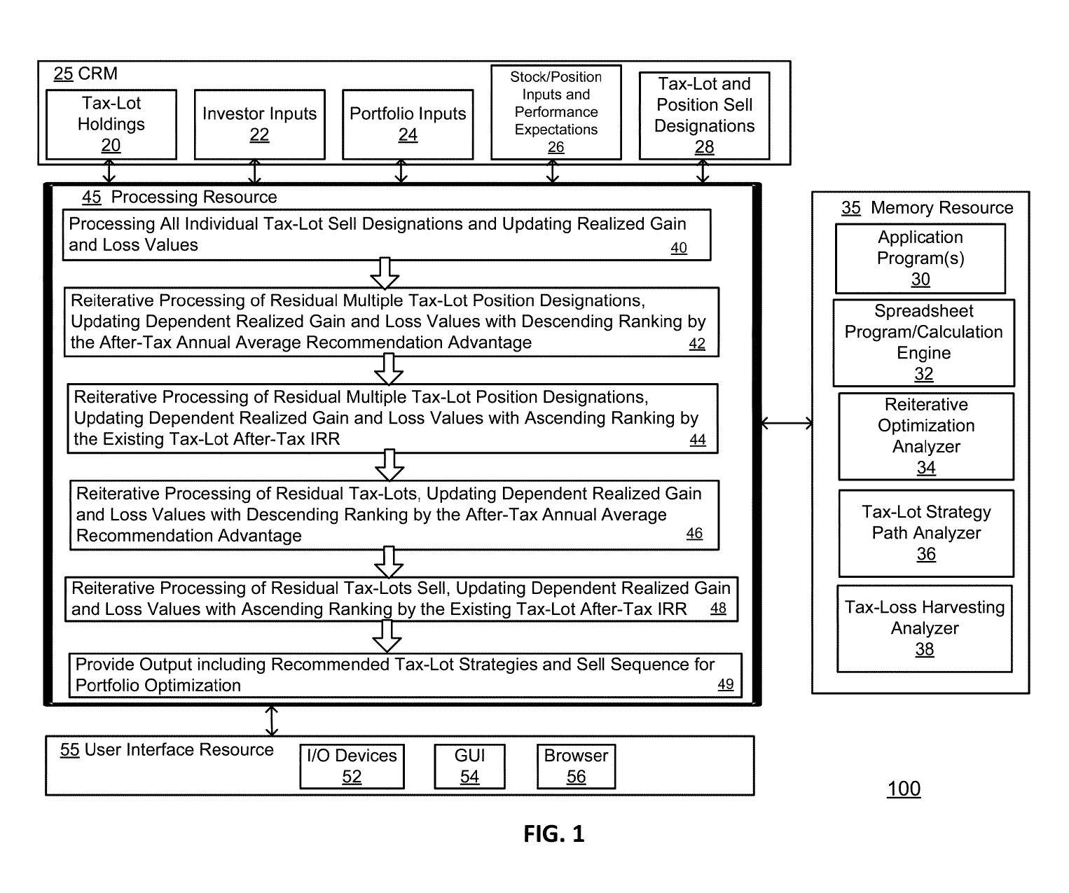

Referring now to FIG. 1, depicted is ETPO 100, an illustrative computer based system and method according to some embodiments of the present disclosure. As will be understood, illustrative ETPO embodiments represented by FIG. 1 are consonant with, and provide for, goals and objectives described hereinabove. It will be understood that ETPO 100 as depicted in FIG. 1 is illustrative and non-limiting; ETPO 100 can use software, hardware, firmware, and/or dedicated logic implemented in various configurations to provide an ETPO system that provides portfolio optimization in accordance with methods of the present disclosure.

In some embodiments, such as that of depicted in FIG. 1, ETPO 100 can include one or more processing resources 45 communicably coupled to (i) at least one tangible, non-transitory computer-readable medium (CRM) 25 (e.g., any one or more of electrical, magnetic, or optical machine-readable medium, which may comprise semiconductor memory, magnetic and/or optical disks, etc., and which may be configured as one or more database, etc.), (ii) another non-transitory computer-readable medium shown in this embodiment as memory resource 35 (e.g., which may comprise semiconductor memory used by processing resource 45 for instantiation of executable code), and (iii) a user interface resource 55 (which may include I/O devices 52, a graphical user interface 54, and a browser 56, and in some embodiments may be implemented as a computing system).

As schematically depicted, inputs to the ETPO processing resource 45 include Tax-Lot Holdings 20, Investor Inputs 22, Portfolio Inputs 24, Stock Performance Expectations 26, and Tax-Lot and Position Sell Designations 28, which are depicted as stored in CRM 25. Based on these inputs, one or more processors 30 executes one or more programs or program modules (e.g., stored in memory resource 35) that may be logically configured as a sequence of five processing module steps 40, 42, 44, 46, 48 to generate ETPO strategy recommendations identifying (among other things) the optimum sequence and combination of tax-lots to sell when tying to raise cash and/or for improved portfolio repositioning. As shown, in step 49, the ETPO tax-lot strategy recommendations are output to user interface resource 55, to thereby inform the user (e.g., investor, portfolio manager,) as to the ETPO strategy recommendations.

ETPO 100 may embody, for example, one or more application programs 30 and/or spreadsheet program 32 (e.g., spreadsheet calculation engine), and further embodies code (e.g., code modules) comprising a reiteration optimization analyzer 34, a tax-lot strategy path analyzer 36, and a tax-loss harvesting analyzer 38, to implement ETPO analysis according to the execution of process module steps 40, 42, 44, 46, 48, and 49. Examples of spreadsheets include commercially available programs such as “EXCEL” or others. A dedicated application program 118 may be implemented in a number of computer programming languages such as “JAVA”, C, C++, APL, COBOL, BASIC or others.

Tax-Lot Strategy Path Analyzer 36, when executed, analyzes individual tax-lots to identify (among other things) the maximal strategy path from among available paths over a time horizon, as described hereinabove. Tax-Loss Harvesting Analyzer 38, when invoked, performs Tax-Loss Harvesting analysis according to, for example, the first and/or second steps of tax harvesting as described hereinabove. And the Reiterative Optimization Analyzer 34, when executed, performs an optimization analysis on multiple tax-lots based on (among other things) the AATAARA and ETLATIRR metrics in accordance with the foregoing disclosure, and as further described hereinbelow. As will be understood, Reiterative Optimization Analyzer 34 may selectively invoke (or may embody) Tax-Lot Strategy Path Analyzer 36 as well as Tax-Loss Harvesting Analyzer 38. And further, in accordance with some embodiments, it will be understood that Reiterative Optimization Analyzer 34 includes code that updates Realized Loss and Gain values for each iteration within the reiteration processing, so that the impact of a proposed/potential sale can be properly accounted for in the subsequent iteration of the reiterative processing, so that an optimum recommended sequence based on descending ATAARA and then ascending ETLATIRR can be determined.

It will be understood that the depicted code modules stored in memory resource 35 is merely illustrative and is non-limiting on the software implementation (e.g., language, programs, code modules, code organization, etc.). For example, in various embodiments, depending on, for example, the software configuration and organization, application program(s) 30 and/or spreadsheet/calculation engine 32 may invoke and/or or embody one or more of reiterative optimization module 34, tax-lot strategy path analyzer 36, and tax-loss harvesting analyzer 38. Similarly, in various embodiments, depending on, for example, the software configuration and organization, reiterative optimization module 34, may invoke and/or or embody tax-lot strategy path analyzer 36, and tax-loss harvesting analyzer 38.

As will be understood by those skilled in the art, the representation of CRM 25 and memory resource 35 as separate blocks does not necessarily mean that these elements are physically distinct (though they may be), or that data and/or code modules depicted therein are necessarily separated into different computer-readable media (though they can be). Similarly, the depiction of CRM 25 as including inputs 20, 22, 24, 26, and 28 does not necessarily mean that all these inputs are stored in the same computer-readable medium, though in some implementations they may be. Memory resource 35 is similarly not limited to a single memory resource component that stores all the depicted code modules 30, 32, 34, 36, and 38. For example, more generally, CRM 25 and memory resource 35 may individually or together be implemented as one or more computer-readable media components, and each of the various data and/or code depicted or otherwise employed in ETPO 100 may be stored on one or more of such one or more computer-readable media. It will be understood, therefore, that the illustrative ETPO 100 shown in FIG. 1 is set forth for ease of description and clarity of exposition in, for example, describing the data or information inputs upon which ETPO analysis is based, along with describing code modules (comprising computer-readable instructions) that can be executed by processing resource 45 in executing ETPO analysis of a portfolio of tax-lots.

It will further be understood that ETPO 100, as depicted, is not limited to a particular type of system; for example, ETPO 100, as schematically depicted, may be implemented as a standalone or networked personal computing device (e.g., personal computer or workstation, comprising at least the processing resource 45, memory resource 35, and user interface resource 55, etc.), or as a client-server system (e.g., where user interface resource 55 may comprise a computer system executing a client that is remote from processing resource 45, which is implemented on a server). For example, ETPO may be embodied as a networked or distributed system such as an Internet-based application and/or a World Wide Web (WWW)-based application on the Internet and connected components. And other embodiments are also possible such as intranet and extranet applications accessible by the browser 56.

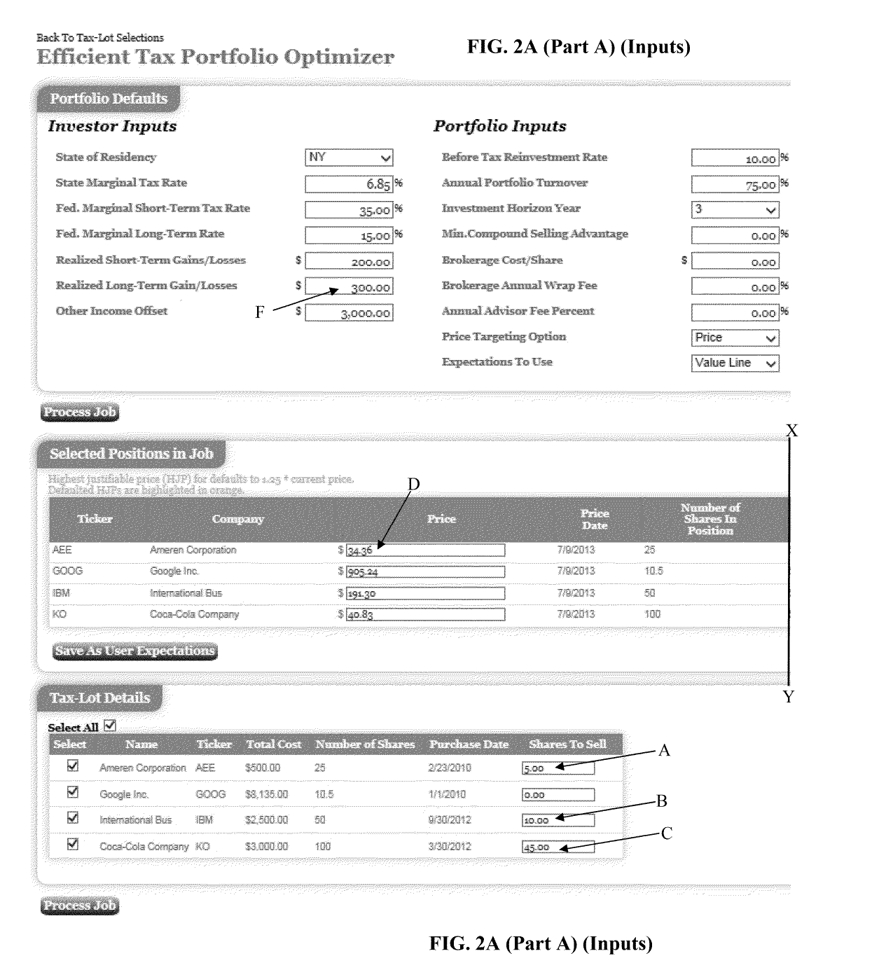

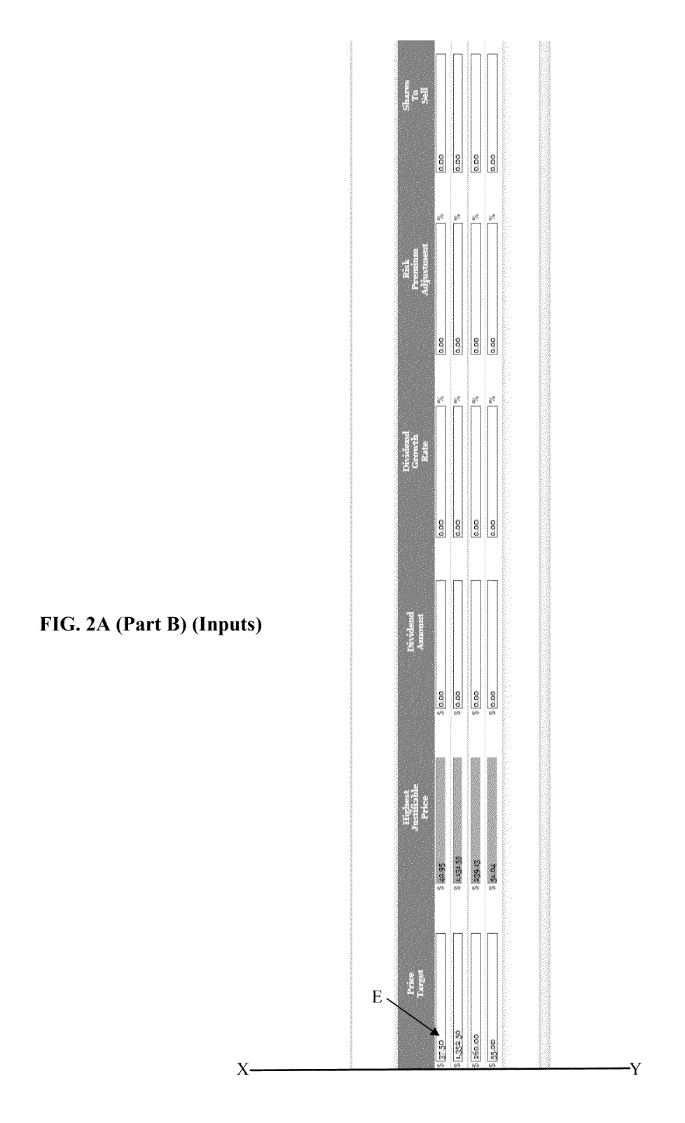

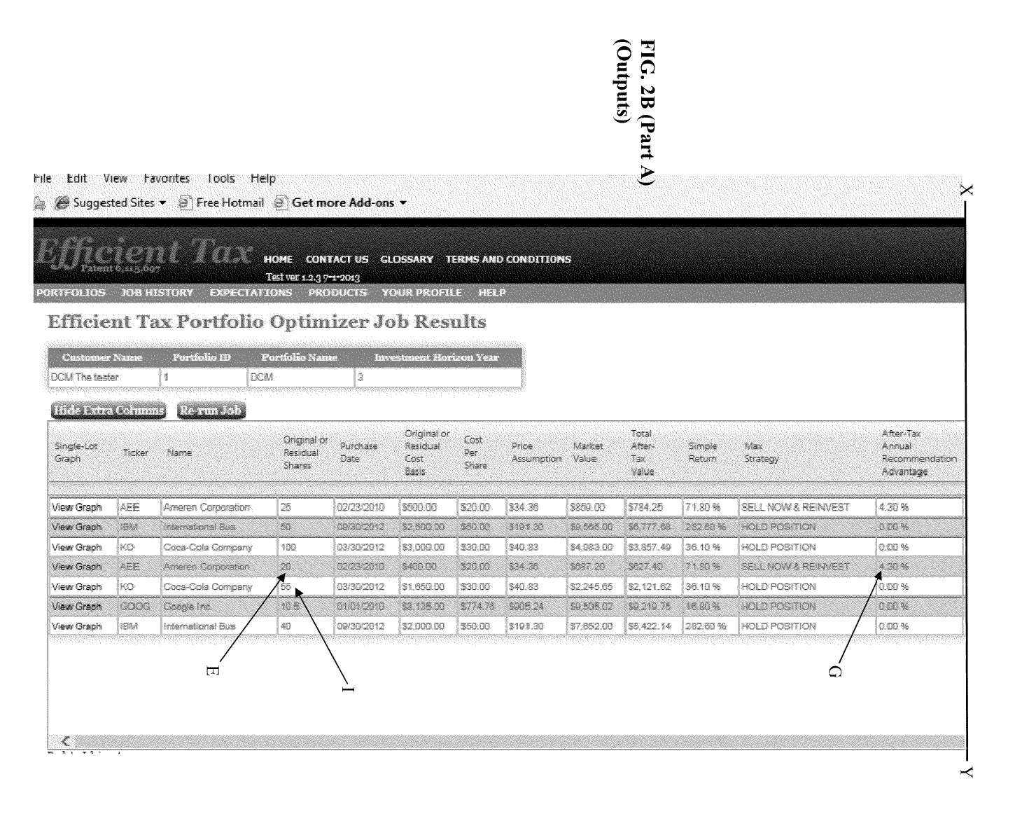

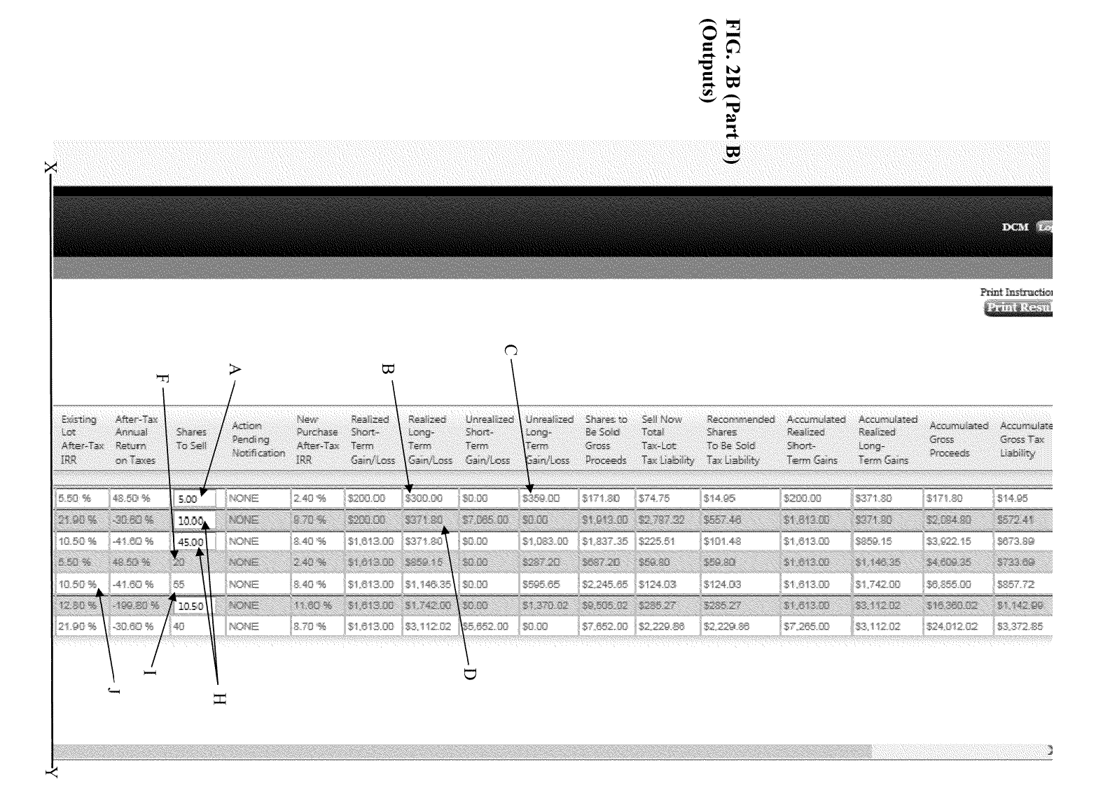

As will be understood by those skilled in the art, each input 20, 22, 24, 26, and 28 represents information (e.g., data) stored in at least one computer-readable medium represented by CRM 25. Various data corresponding to this input may be based on user inputs, public and/or proprietary or third party data feeds, etc. In accordance with some illustrative and non-limiting embodiments, inputs 20, 22, 24, 26, and 28 may comprise the following (FIGS. 2-5, described in detail further hereinbelow, depict various illustrative user interface screenshots that include corresponding input fields).

Tax-Lot Holdings 20 comprises the data or information concerning individual tax-lots in a portfolio. A tax-lot is a number of shares purchased on a particular day at a particular price, for a total cost of the tax-lot, or cost basis, including any commission. Shares of the same company purchased on the same day at a different price, or even at the same price on the following day, represent a different tax-lot. A tax-lot generates a taxable event when it is sold. By way of example, via user-selectable functions provided by ETPO's user interface, tax-lots may be uploaded into a portfolio (e.g., stored in CRM 25) from an external file, and/or individual tax-lots may also be created manually.

Investor Inputs 22 comprise facts/information regarding each investor that is pertinent to the tax impacts of selling a security. Investor Inputs 22 include the following.

State of Residency (and State marginal tax rate): In accordance with some embodiments, ETPO accounts for the impact of state taxes impact the economics of each taxable tax-lot. For example, ETPO may store/maintain individual state tax rates available in the public domain, and provide a drop-down menu containing each State's tax rate, as a default option, in order to assist users. Users may edit and save each portfolio's Defaults, via the user interface.

A User may select a State of Residency in the drop-down menu, after-which a defaulted value will appear in the State Marginal Tax Rate field. A User or an Investor may over-write or input their own marginal tax rate value that they may be subject to, over and above Federal tax rates. According to some embodiments, ETPO analysis calculates the aggregate total tax impact on a tax-lot, or series of tax-lots, with the following formula: Total Marginal Short-term Tax Rate=(Federal Short-term Tax Rate)+(1-Federal Short-term Tax Rate)×(State Marginal Tax Rate). As State taxes are deductable for Federal purposes, the formula is repeated, taking proper consideration for long-term marginal tax rates.

Federal Marginal Short-Term Tax Rate and Federal Marginal Long-Term Tax Rate: By way of example, these values may be defaulted as 39.6% and 20.0%, respectively, and user's may modify these defaults via the user interface (e.g., comprising screenshots depicted in FIGS. 2-5).

Realized Short-Term Gains/Losses: Accurate entry of these values is important for a proper Efficient Tax Portfolio Optimizer Analysis, such that it provides an optimization that is as accurate as possible, based on accurate values for Short-Term Gains/Losses being required to properly assess and take full advantage of any Tax-Loss Harvesting opportunities. This value should include the value of net Short-Term Gains and Losses year-to-date, plus any net Short-Term Tax-Loss Carry-Forward of previously realized short-term loss values, that have not yet been utilized to offset any gains.

Realized Long-Term Gains/Losses: This value should include the value of net Long-Term Gains and Losses tax-year to-date, plus any net Long-Term Tax-Loss Carry-Forward of previously realized long-term loss values, that have not yet been utilized to offset any gains.

Other Income Offset: Normally, capital losses generated from the sale of a capital asset, a stock for example, cannot offset ordinary income, and reduce ordinary income taxes. But there is an exception. Single tax-payers may offset up to $3,000 of capital losses each year against ordinary income. There are special considerations for married couples, depending upon how they file; for example, a married couple, in aggregate, possibly may be eligible to deduct capital losses against ordinary income, greater than $3,000 between the two of them. ETPO, in an effort to maximize the value of this tax benefit, will preserve the value of a long-term capital loss eligible to reduce ordinary income, by not utilizing its tax savings impact to reduce a lower tax-rated long-term gain; instead saving it for offsetting and reducing ordinary income, and its higher associated tax cost. For many investors, this is not a big item, but in order to be thorough, ETPO, according to some embodiments, includes it.

Portfolio Inputs 24 are those inputs related more particularly to each portfolio. Investor Inputs 22 affect all portfolios that may be owned by a single tax-payer; however, each portfolio may have its own unique characteristics, which are reflected by Portfolio Inputs 24, which may include the following.

Before Tax Reinvestment Rate: A tax cost related to the selling of a taxable security may be recovered by reinvesting any after-tax proceeds in an investment with a better return potential than an existing holding is expected to achieve. The Before Tax Reinvestment Rate is the rate an investor expects to achieve through reinvesting after-tax proceeds from the sale of a taxable security. It is important for this number to be realistic. A too optimistic number may have an investor selling too soon, and being more aggressive with turnover than can be economically justified. Too low a number may result in opportunities to sell and reinvest for higher after-tax returns, being missed. In some embodiments, ETPO provides a default value of 9% as a Before Tax Reinvestment Rate, representing approximately the long-term return history of the U.S. stock market, under normal market conditions. What rate may best apply to a given portfolio under consideration may be affected by things such as asset allocation, investor risk tolerances, and current market valuations.

Annual Portfolio Turnover: If an investor has ten equally valued stock investments, and sells and replaces five of them in a year, then they are generating 50% in Annual Portfolio Turnover; thus, it takes two years to sell and replace an entire portfolio value, with the investor holding onto each position an average of a year. In other words, a 50% or less Annual Portfolio Turnover input will result in Efficient Tax Portfolio Optimizer assuming all reinvested monies will be in positions that are held more than a year. If an investor sells and replaces all ten stocks, they have a 100% Annual Portfolio Turnover. Which assumes all stocks are held less than one year. Therefore the higher an Annual Portfolio Turnover, the higher effective tax rate an investor is likely to be subject to. Efficient Tax Portfolio Optimizer calculates an Effective Tax Rate influenced by portfolio turnover. A 50% Annual Portfolio Turnover is assumed to generate a capital gains tax rate on reinvested assets at the Long-Term Marginal Tax Rate, while a 100% or greater Annual Portfolio Turnover input value will generate an effective tax rate at the Short-Term Marginal Tax Rate. In some embodiments, ETPO calculates a linear relationship between those two values, such as, for example, a 75% Annual Portfolio Turnover will impact an Investor's Effective Tax Rate by being half way between the Marginal Short-Term Tax Rate and the Marginal Long-Term Tax Rate. The higher the Annual Portfolio Turnover inputted within the 50-100% range, the harder it will be to justify a sale.

Investment Horizon Year: In accordance with some implementations, the Investment Horizon Year is an important input for three key reasons. The first is that, the longer time horizon an investor allows themselves to recoup a tax cost and profit from a sale by the prospect of generating after-tax excess return over time through a more promising investment opportunity set, the more likely they are able to justify a sale. A shorter investment horizon will require a higher reinvestment rate of return, in order to recover a tax cost over the time horizon designated. The second reason Investment Horizon Year is important is that stock price forecasting gets more difficult, the longer the horizon, which means a longer investment horizon will generate more Alpha generating opportunities given a reinvestment rate of return, but is more difficult and risky to forecast. And thirdly, when an ETPO analysis is processed, even though in some embodiments each tax-lot evaluated has a three, four, and five year analysis associated with it (which may be depicted to the user in a Graph), only one ranking or sequencing of sale candidates is generated with each Job processed, in accordance with some embodiments. And that ranking or sequencing of sale candidates is governed by the Investment Horizon Year.

Minimum Compound Selling Advantage: Absent the use of this special tool, Efficient Tax Portfolio Optimizer will recommend the selling of a tax-lot whenever there is an advantage to do so in terms of generating an After-tax Annual Average Recommendation Advantage, or Alpha, even just one extra penny. Accordingly, ETPO provides for the opportunity/option to input, in effect, a minimum after-tax annual Alpha value as a minimum criteria for a sale. For example, if an investor inputs a 1% value in this field, Efficient Tax Portfolio Optimizer will artificially raise the end-of-horizon after-tax value for Holding a tax-lot, by 1% per year on a compound basis, making it more difficult for a reinvestment to catch up and beat a Hold decision. Therefore the After-Tax horizon value for a Hold will no longer be an Absolute number an investor could expect to have at the end of a chosen investment horizon, but rather an absolute number adjusted by a relative factor. The remaining values such as the Alpha number (e.g., After-Tax Annual Recommendation Advantage) generated on the Job Results Page, and the Existing Tax-Lot After-Tax IRR values will remain correct, on an absolute basis. But the After-Tax Annual Average Recommendation Advantage percentage value will be adjusted by this input.

Brokerage Cost/Share: If brokerage costs are high, this value will materially impact an Efficient Tax analysis. If they are not, not so much. As many institutional brokerage costs are assessed on a cents per share basis, ETPO provides for inputting the brokerage cost input in that format. An individual investor, or manager who has brokerage impact costs as a flat rate for each trade, such as $8.95 per trade, and on average invests $5,000 per tax lot, (considering that stocks on average, as a result of stock splits, have prices in a distribution around $30 per share), might then input in this value, 5.4 cents. ($5,000/$30)=166.7 average shares per tax-lot. ($8.95/166.7)=5.4. Insofar as brokerage costs are usually not significant, this value generally will not change ETPO results materially, and thus may be optionally omitted, or ETPO may employ a default amount. But to the extent they are inputted, the results will be more precise.

Brokerage Annual Wrap Fee: Many brokers charge a fee as a percentage of the assets under management, as an aggregated cost of both management services and brokerage transaction costs. The Brokerage Annual Wrap Fee, when inputted, will reduce the accumulating after-tax horizon values by this percentage amount, on an annual basis.

Annual Advisor Fee Percentage: Registered Investment Advisors generally charge for their services, a percentage of the assets under management. 1% for example. As with the Brokerage Annual Wrap Fee, this value will be deducted from accumulated end-of-horizon values.

Price Targeting Option: ETPO, according to some embodiments, provides for two methods of price targeting: Price-based, and Earnings-based. Because of the importance of price targeting in After-Tax Portfolio Optimization, the Price-based method maintains an inputted price target as a static value across the three, four and five year horizons, in accordance with some embodiments. Alternatively, the Earnings based method, requires a current year earnings estimate, an annual compound growth rate, and a Price Earnings Multiple to apply against an end-of-horizon projected earnings forecast, in order to arrive at a price target, which will result in a different price at the end of each investment time horizon. By way of the user interface, if a user toggles the Price based option, then the price targeting input fields below, by Position, (a collection of tax-lots of the same company), will just have one input field for price target provided. User selection of the Earnings based option, will convert the input fields to the ones described.

Expectations To Use: Users may toggle and select to utilize, as stock price forecasts over their chosen investment horizon, either their own User saved expectations, for either Price or Earnings based options. In some implementations, third party forecasts may be used. For example, in some implementations, Value Line expectations may be used when selecting the Price based option, and Dynamic Capital Management's forecasts may be used when using the Earnings based option.

Stock/Position Inputs and Performance Expectations 26 comprises inputs related to each company (ticker) for the tax-lots (regardless of how many tax-lots may be owned within a multi-lot position), within the portfolio to be analyzed by ETPO, and may include the following, with respect to each company represented by the tax lots in the portfolio to undergo ETPO analysis according to some embodiments of the present disclosure.

Price: ETPO may be configured to automatically retrieve Delayed Market Pricing from BarCharts, during the Job Creation process. If prices are not available for a particular company, and/or the User wishes to supply more real-time pricing information, and/or the user wishes to simulate a price, the user may over-write the value in the Price field.

In addition, ETPO identifies, based on the inputs 26, the Price Date, and the total number of shares in a position in a company, which may include more than one tax-lot. And then the Price-based Price Target (if selected) is also an input that may be displayed. Both price and price targets remain the same across all tax-lots within a Position. Current price or a price target is not affected by a date of purchase or the cost of a tax-lot. In addition, a User may “Save As User Expectations” via the user interface, whatever values are resident in any of the Expectation Set input fields. For example, Value Line price targets may be saved as User Price based targets, and DCM Expectations Sets may be saved as User Earnings based Expectations, or any other value may be inputted and saved as a User Expectation.

If Earnings based price targeting were selected as an input, then instead of a single Price target (which would remain the same for the end of a three, four or five year investment horizon), a price target is calculated and derived by starting with an Earnings Base, whereby an Earnings Growth Rate is applied on a compound basis through the end of an investment horizon, and then that number is multiplied by a PE Target. In accordance with some embodiments, that information may be displayed to a user in a company ticker row in a job positions screen (rather than a single Price target). As noted, a user may either save and use their own Earnings based targeting inputs, or may choose to use Dynamic Capital Management's.

Highest Justifiable Price: Another value included in a company's input set 26 (e.g., as may be displayed in a given row of a user interface screen; e.g., selected position in job screenshot portion in FIGS. 1A, 2A, 3A, 4A, and 5A) is for what is referred to as the “Highest Justifiable Price”(HJP). In accordance with some embodiments, that value comes into play when a company may be over-valued in the short-term window. If a company is viewed to be so materially over-valued that the future performance of the investment on an after-tax value is threatened as a result of the potential of a stock price dropping to its highest reasonable, or justifiable price at any time, and more value is likely to be lost on an after-tax basis due to the price dropping than would be saved by waiting to the long-term window for a lower tax rate, compounding-impacts out to the end of an investment horizon included, then a stock can justifiably be sold in the short-term window.

Because this feature has a material impact on the tax economics of an individual tax-lot, in accordance with some embodiments, we require the User to be pro-active in the use of this value, in order for it to be included in an analysis where it could impact the results. One way is to use DCM expectations. DCM calculates and distributes a Highest Justifiable Price on most of the members of the S&P500 and Nasdaq100, plus some additional companies. If a User toggles the Earnings based option, and chooses the DCM Expectations (which may be set as the default ones, since the present inventor knows there was fundamental rigor attached to the development of that value), those values will automatically populate the Highest Justifiable Price input field. In addition, if a User deliberately saves a value for Highest Justifiable Price either within the Input Page, or within the Expectations tab, then those values will be defaulted within the Input Page. However, if neither of those conditions apply, then, in accordance with some embodiments, the system will take the Current Delayed Market Price, and multiply it by 125% as a default. Since the HJP only impacts an analysis when the market price is above the HJP in the short-term window, defaulting the price below the HJP takes any impact out of the equation. The HJP values that are calculated and inputted as 125% of market prices may be shown in an identifying color (e.g., Orange), so that the User knows they have to make a deliberate input decision if they wish to invoke the impact of any Highest Justifiable Price.

Dividend Amount: This is another input that, in some embodiments, requires a deliberate decision by the User. Dividend amounts, and their related Dividend Growth Rates, may be defaulted as either a Saved User Expectation, or as a result of selecting DCM as an Earnings based Expectation Set source. This is because dividend amounts are often not stable, and are often reduced dramatically. As DCM reviews, for the stocks it follows, over ten years of dividend history, pay-out ratios and growth rates, and assesses whether a dividend might be vulnerable to a drop due to dividends being distributed in an amount that further threatens an already weak balance sheet, DCM reduces a dividend amount to a Sustainable Dividend Amount, so as not to make dividend distribution Expectations very speculative. A DCM Expectation Set selection will have its dividend and dividend growth rate values defaulted as Position Defaults, as will saved User Dividend Amount and Dividend Growth rates. However, again, if neither of those conditions are present, those values are defaulted to be zero.

Risk Premium Adjustment: Risk Premium Adjustment is another Position related input. If a held position is more or less risky than an alternative investment, than that of a reinvestment option, it can be value added to take that into consideration. If an investor's choice is whether to hold onto U.S. Steel with a high Beta of almost 2, versus a reinvestment alternative with the risk profile of the market at large with a Beta of 1, ETPO can fundamentally account and adjust for that rationally as well. If an investor were to conclude that in order to accept the risk of owning a steel company, and U.S. Steel in particular, could only be justified with an extra 3% per year in return, then the investor could, for example, put a plus 3.0 value in the Risk Premium Adjustment field (which may be saved as a User Expectation, as mentioned before). The impact that value has on an ETPO analysis is that the Hold End-of-Horizon After-tax value would be reduced by 3% per year of an investment horizon, thus making it easier and more justified to replace a riskier stock with a tax liability with a less risky alternative, than one with less risk. And otherwise, when a stock is less risky than the market as a whole, such as with a Johnson & Johnson with a Beta of 0.5, a lower return requirement by, for example, 2%, than would be needed to be rewarded for full market risk might be inputted. This would increase the Hold After-Tax End-of Horizon value by 2% per year, thus making an alternative investment, all else being equal, less justified, unless it could more than outperform by the value of the Risk Premium Adjustment. Accordingly, some embodiments of ETPO may include this value-added input option.

Shares To Sell: In accordance with some embodiments, Shares To Sell can have different meanings depending, for example, on the context of the illustrative ETPO user interface, such as with respect to illustrative screenshots depicted in the accompanying figures. For example, Shares to Sell can mean any one of the following: (1) the number of shares Designated by a User within either the Portfolio, Input, or Results pages/screens, to be sold out of a particular tax-lot, and therefore (in some implementations) alphabetically ranked by ticker, at the top of a Results Set optimization ranking; (2) the number of shares Designated by a User within the Input page, to be sold among one or more tax-lots included in a multi tax-lot stock position; and (3) the number of shares recommended to be sold out of each individual tax-lot, within the Results Set portfolio optimization sell candidate ranking, and included in all the related ETPO tax-lot calculations (which may also be converted to an individual Shares To Sell Tax-Lot Sell Designation within the Results page, then Re-Processing an EPTO Analysis directly from the Results page.

In the case of Shares To Sell on an Input Page that may be displayed to a user for entering input information such as that described hereinabove (see, e.g., FIGS. 2A, 3A, 4A, 5A), Shares to Sell may represent the minimum number of shares an Investor or User wishes to sell out of an entire position of a particular stock, and such Designations are further described below with respect to inputs relating to Tax-Lot and Position Sell Designations 28.

ETPO analysis inputs referred to as Tax-Lot and Position Sell Designations 28 may include two types of Shares To Sell Designations that may be input by the user. By way of example as to the utility of these inputs, it may be appreciated that there are many reasons to sell a stock, other than for reasons of valuation; for example, having too much of a given stock.

Since a Position may be made up of just one tax-lot, and an investor may want part if it to be sold, ETPO according to some embodiments provides three different opportunities for a User to Designate at the Tax-lot level, the number of Shares To Sell: first at the point in which they select the individual tax-lots to be included in a Job Creation (i.e., where the user effectively can select a portfolio of tax-lots to undergo ETPO analysis from among all tax-lots held by the user; in some embodiments the user may select all such held tax-lots); Second, within the Input Page, where they may review and change an already made individual tax-lot Sale Designation; and third, again within the Job Results Page, whereby a User may change their mind again, after seeing the Results Set, change an individual tax-lot Shares to Sell Designation, and Re-run a Job without returning to the Job Input page.

It will be understood that an individual tax-lot Designation does not go through an optimization process. The User is deciding to sell some or all of a tax-lot, independent of an optimization process. A reason ETPO provides a user this flexibility to Designate Shares To Sell at the individual Tax-lot level is that it is important that ETPO update the Realized Gains/Losses values with the impact of those decisions, before the optimization process begins.

The second kind of Shares To Sell Designation 28 is at the Position level. An investor may wish to sell a number of shares among more than one tax-lot making up an entire position, but doesn't know which tax-lots to sell. Some may have been purchased at different costs, and on different dates, with some being in a profit, and some with a loss. While some are still short-term and others are long-term already. A Position Designation will cause Efficient Tax Portfolio Optimizer to recommend selling those tax-lots first within a position, that when sold, would generate the greatest excess return through a sale and reinvestment. And if additional shares are to be sold within a position than would generate an excess return by doing so, then Efficient Tax Portfolio Optimizer identifies and recommends selling those additional tax-lots first, in part or in whole, that have the least after-tax return potential remaining, based on calculating and comparing their existing after-tax value with their projected end-of-horizon after-tax value, while keeping in a portfolio (e.g., by ranking lower for potential sale), those tax-lots within a Position that retain the greatest after-tax return potential.

In other words, a user may specify a Position Shares To Sell Designation if, for example, the user wishes to reduce the number of shares they may own across a Position with multiple tax-lots, because, for example, they wish to reduce their exposure or take some profits. Based on that Position Shares to Sell Designation, ETPO will perform an optimization Analysis to recommend selling owned tax-lots in a sequence that identifies tax-lots to be sold first that would generate the greatest excess return, or Alpha, through a sale and reinvestment. And then, if not all the number of shares that are wished to be sold generate an Alpha, the ETPO optimization Analysis will recommend that the investor sell those tax-lots first that have the least after-tax return potential remaining

As depicted by FIG. 1, based on the above-described inputs that may be stored in CRM 25, processor resource 45 executes a sequence of steps, including steps 40, 42, 44, 46, 48, in accordance with executable code (computer-readable instructions) comprising modules 30, 32, 34, 36, and 38 stored in memory resource 35, to determine and provide for as an output an optimized ranking of which individual tax-lots should be sold in a sequence that, based upon stock price forecasts an investors believes are reasonable, maximizes future after-tax wealth accumulation. In accordance with some implementations, ETPO thus provides for optimizing a portfolio by guiding and informing an investor as to when capital should be re-deployed when higher after-tax returns are likely available through alternative investments, and to retaining the best investments with the highest after-tax return potential.

As may be understood in view of the foregoing, reiterative processing analysis according to ETPO optimization analysis (e.g., in accordance with invoking, for example, Reiterative Optimization Analyzer 34) involves a highly calculation intensive and rigorous portfolio data analysis mining optimization process, wherein the ETPO Analysis first identifies which tax-lot, among all of those within a portfolio, if sold, given inputs like cost basis, market price, up-to-date realized gain and loss values and tax rates, would generate the greatest excess after-tax return or Alpha through a sale and reinvestment versus holding onto an existing investment.

Then by updating the Realized Gain and Loss values with the forecasted gain/loss realization impacts from that sale candidate, ETPO optimization analysis (e.g., in accordance with invoking, for example, Reiterative Optimization Analyzer 34) identifies, from the remaining tax-lots, which tax-lot sale candidate would generate the greatest Alpha or excess, risk adjusted, return, if desired, that tax-lot thereby becoming the second tax-lot in sequence to sell in an optimization process. And this reiterative process is repeated until all tax-lots are ranked in descending order of potential Alpha forecasted, if any.

And then, after all tax-lot candidates that would generate an extra return if sold are identified and ranked, an ETPO optimization analysis (e.g., in accordance with invoking, for example, Reiterative Optimization Analyzer 34) converts the ranking sequence such that tax-lots with the least Existing Tax-Lot After-Tax IRR are suggested to be sold first, in the end, resulting in a ranking that recommends the selling of tax-lots that are likely to generate the greatest excess return first, and ultimately recommending keeping those tax-lots with the greatest after-tax return potential remaining And that is the basic operation underlying how ETPO effectively minimizes taxes, but not at the expense of sacrificing future after-tax wealth accumulation by doing so.

In some embodiments, such as depicted in FIG. 1, ETPO 100 may be implemented such that such an ETPO optimization analysis (e.g., in accordance with invoking, for example, Reiterative Optimization Analyzer 34) is implemented in two stages: first for multiple tax Sell Position Designations, and then for residual tax lots in the portfolio (e.g., user-specified tax-lots in job).

More specifically, in accordance with the illustrative processing executed by processing resource 45, an ETPO Analysis includes five steps to provide its overall Optimization process. As one skilled in the art can understand, inputting up-to-date realized gain and loss values is important in the portfolio optimization process.

As discussed, keeping in mind that there are many reasons to sell other than valuation, such as having too much of any one stock, ETPO Portfolio Optimizer provides the user, at three different points of time, with the flexibility of Designating any number of shares to sell from any specific existing tax-lot, as an independent decision.

Accordingly, in step 40, ETPO accounts for all such individual tax-lot sale Designations, prior to any reiterative optimization process, by accruing (e.g., and displaying) gross and after-tax proceeds, in addition to updating the realized gain and loss values, as a precursor to the full optimization process. As such, an accurate accounting of any resulting impacts on realized gain and loss values will be calculated for any such Tax-Lot Sale Designations. In accordance with some embodiments, ETPO ranks all Tax-Lot Sale Designations alphabetically by ticker, for consistency, recognizing that regardless of which sequence Designated shares are sold, the end-resulting Realized Gain and Loss values will be the same.

In Steps 42 and 44, ETPO performs ETPO optimization analysis with respect to Multiple Tax-Lot Position sale Designations, in the event that any such Sale Designations have been input by a user. ETPO thus recognizes and accounts for an investor who may want to sell or designate for sale, a specified number of shares from a position, but in many cases, suh a position will be made up of more than one tax-lot. For example, 500 shares of IBM may be owned across four different tax-lots purchased on different days. And because of the position's increased portion of a portfolio due to its rise in price, an owner may want to sell 175 shares, but does not know which shares should be sold from the possible four tax-lots in the 500 share position.

In step 42, ETPO Analysis determines which shares from which tax-lot or sequence of tax lots, if sold, would be forecasted to generate the highest after-tax extra return by doing so. More specifically, step 42 comprises reiterative processing of a multiple tax-lots corresponding to a position for which a Position Sell Designation has been input/specified, to provide a recommended tax-lot sale sequence with descending ranking according to After-Tax Annual Average Recommendation Advantage, wherein the realized gain and loss values are updated on each iteration, including the last.

And then, in step 44, if more shares were Designated to be sold from the Position than would generate a forecasted Alpha if sold, reiterative processing according to ETPO analysis would be performed to identify potential additional share sales that would come first from any residual tax-lot, that if shares were sold thererom, contain the least after-tax return potential remaining, and further potential additional share sales would come from tax-lots ranked in ascending order with respect to Existing Tax-Lot After-Tax IRR, thereby recommending keeping tax-lots with the greatest after-tax return potential. Again, the realized gain and loss values are updated on each iteration.

All else being equal, short-term losses would be sold first, then long-term losses, then long-term gains, and then finally short-term gains.

Any Residual Shares not sold based on a Sell Designation are then included in the main optimization process of steps 46 and 48. Again, in accordance with ETPO optimization analysis, in step 46, with respect to such residual shares, tax-lots are ranked to be sold in a sequence such that those that would generate the greatest After-Tax Alpha are sold first. And then in step 48, any remaining tax-lots still suitable for ownership, are ranked as a sale candidate from the least after-tax return potential remaining to the highest, such that future after-tax returns are forecasted to come from existing tax-lots with greater after-tax return potential remaining

In step 49, the output of the ETPO analysis, comprising recommended tax-lot strategies and potential sale sequences for portfolio optimization over the investment period/horizon, may be provided or output (e.g., to the user via the user interface resource 55.

### EXAMPLES

The following illustrative examples are set forth with respect to screenshots representing a user interface present by ETPO 100, and are not limiting of the present invention. More specifically, in view of the foregoing disclosure, and given the original patented methods of the prior patents, and the values derived thereof that are primary inputs into ETPO, the description of ETPO itself, and its goals, the ETPO optimization process, in some implementations, includes and embodies the following illustrative non-limiting methods and sequence of analysis, in accordance with some embodiments of the present invention. These Figures, provided by way of non-limiting example, depict inputs and outputs of the front-end user interface, referencing the above mentioned descriptions. As will be understood, each of the enumerated Figures (i.e., FIGS. 2A, 2B, 3A, 3B, 4A, 4B1, 4B2, 5A, 5B1, and 5B2) is presented in two parts (i.e., Part A and Part B) to depicts one screenshot: Part A depicts the left-hand portion of the screenshot, and Part B depicts the adjoining right-hand portion of the screenshot, with a break-line identified by reference characters X and Y identifying adjoining portions of the left-hand and right-hand portions of the screenshot.

### Example 1

An investor may Designate how many shares, if any, of any individual tax-lot they wish, should be sold, separate from the optimization process. The results of these Designation decisions will affect and will be included in the updating of the realized gain and loss values, along with other accumulating values, such as gross and net after-tax proceeds. This method's results are depicted in FIG. 2B (Outputs), along with the inputs that generated the results, in FIG. 2A (Inputs). Wherein there are four tax-lots included in a Job example, where three of them have Designations to sell one or more shares. Leaving the residual shares, and the remaining tax-lot to be included in the ETPO optimization process. With the important realized gain and loss values updated as a result of the Position Sell Designations.

Specifically, FIG. 2A (Inputs) illustrates not only all the relevant inputs necessary for an ETPO process, but also, in this case, the Designation of 5 shares, of a 25 share purchase of an Ameren tax-lot on Feb. 23, 2010 to be sold, identified as input Data Element “A”. Along with 10 shares of an IBM tax-lot purchase of 50 shares on Sep. 30, 2012 identified as data element “B”, and 45 shares of a Coca-Cola tax-lot purchase of 100 shares on Mar. 30, 2012 identified as Data Element “C”, also Designated to be sold. It is critical that any separate decisions to sell any portion of a tax-lot apart from the optimization portion of the ETPO process, be included in the full ETPO process in order for their impacts on any Realized Gain or Loss values can be updated, necessary for a proper ETPO process to be completed.

Also referenced in FIG. 2A (Inputs) is Data Element “D”, representing a current market price, and Data Element “E” a three year Price Target for a stock. Other performance expectations included in the input set are Dividend Amount, Dividend Growth Rate, along with Risk Premium Adjustment, and Highest Justifiable Price, an input important in the Short-Term tax window. Also indicated is Data Element “F”, the beginning value for Long-Term Realized Gain/ Loss input value, again referenced in FIG. 2B (Outputs).

FIG. 2 B (Outputs) is the Results set from the inputs provided in FIG. 2A (Inputs). There are several important outputs to describe in FIG. 2B (Outputs), including Data Elements:

A; Since it doesn't matter mathematically what sequence Designated tax-lot shares are sold first in order to update their sum total impact on any Realized Gain & Loss values for an ETPO process, we choose to sequence them alphabetically by ticker. Therefore Data Element “A” represents the Designated selling of 5 of the original 25 shares of Ameren purchased on Feb. 23, 2010, ticker AEE, first.

B; Data Element “B” indicates that the beginning value of the Long-Term Realized Gain/Loss value is a positive $300.00.

C; Data Element “C” is the Unrealized Long-Term Gain of the entire 25 share Ameren purchase on Feb. 23, 2010 of $359.00.

D; Data Element “D” is the new Long-Term Realized Gain/Loss value updated by the impact of selling 20%, or 5 of the 25 shares of the Feb. 23, 2010 Ameren tax-lot, which amounts to $71.80. Therefore the new resulting Realized Gain/Loss value is $371.80 as an input value for the next ETPO process, (whereby all remaining tax-lot shares, original or residual shares, are compared, all using the same Realized Gain/Loss values), when the $71.80 is added to the starting $300 value. “Shares To Sell” in this example is 5, and represents the number of shares of a tax-lot, in part or in whole, that were used in the calculation set. They can be changed in the Results Set, and Re-run, as an ease of use function in the system. Both the Short and Long-Term Realized Gain/Loss values are updated as such, respectively, in every step along the ETPO process.

E; Data Element “E” are the Residual Shares remaining of the original 25 share purchase of Ameren on Feb. 23, 2010 after the 5 share Designation are accounted for. Each tax-lot is re-evaluated in the ETPO process until all of its shares are included in an ETPO “Shares To Sell” ranking process.

F; Data Element “F” indicates that after all the Tax-lot Designations have been processed, the remaining 20 shares of the 25 shares of Ameren purchased on Feb. 23, 2010, not only is the highest ranking Sell Now tax-lot because it has a positive After-Tax Annual Average Recommendation Advantage, it is the only one within the group of tax-lots as such.

G; Data Element “G” confirms, with a positive 4.3% value, that it is the only and therefore highest ranking tax-lot with a positive After-Tax Annual Average Recommendation Advantage.

H; Data Elements “H” represent, in alphabetical order, the other two tax-lot Designations previously identified in FIG. 2A (Inputs).

I; Data Elements “I” are the remaining Residual 55 Shares of the 100 Coca-Cola shares purchased on Mar. 30, 2012, after the 45 share Designation is included in Shares To Sell previously in the ETPO ranking

J; Data Element “J” justifies the remaining 55 Coca-Cola Mar. 30, 2012 tax-lot shares as the first non-Designated, and non-Sell Now tax-lots, or a Hold Position rather, shares to be sold, as its Existing Tax-Lot After-Tax IRR value is less than the ones that succeed it.

The remaining two tax-lot Shares To Sell values in the ETPO ranking process are governed by their rising Existing Tax-Lot After-Tax IRR value, and the the fact that one of them, IBM, has 40 Residual Shares of an original 50 share purchase on Sep. 30, 2012, impacted by the prior 10 share tax-lot Shares To Sell Designation.

### Example 2

An investor may further Designate, how many shares, among a number of tax-lots, associated with a particular company, or rather a total position in a company, they wish to sell. For example just to reduce their overall exposure or investment in a particular company.

ETPO will generate a sequence of selling among multiple tax-lots in an assembled position, in a manner consistent with the general optimization “Serial Stream” process but in its own “Mini Serial Stream” instead.

If any shares from a particular tax-lot that have been Designated to sell at the tax-lot level, any resulting residual shares, along with any other tax-lots within a position, will first be evaluated for which tax-lot, if it were to be sold, would generate the greatest, if any, After-Tax Annual Average Recommendation Advantage. This would be done either within a Position Designation Mini Serial Stream, or for a full remaining portfolio optimization regular Serial Stream. Resulting in the need to update the realized gain and loss values for the next comparative analysis within a Serial Stream, or in this case, a Mini Serial Stream, on the remaining tax-lots within a position. To identify among the remaining full and residual tax-lots within a position, which, if sold, would generate the highest After-Tax Annual Average Recommendation Advantage. Or rather then the second tax-lot to sell shares from, within a position, in an optimization Mini Serial Stream process method.

This Serial Stream, or Mini Serial Stream process is done a minimum of (n−1) times, with “n” being the number of tax-lots to be evaluated in an Efficient Tax Portfolio Optimizer Job, or within an individual position, respectively. Once all tax-lots within a position, that would generate an After-Tax Annual Average Recommendation Advantage, have been identified and exhausted, if there are any, then a reiterative sequential process will continue, updating realized gain and loss values along the way, using the least Existing Tax-Lot After-Tax IRR value tax-lot as the next tax-lot identified to be sold, in the optimization method. In effect, allowing the investor to raise cash in a manner that generates the greatest Alpha first, and then causes the least reduction in potential future returns by keeping tax-lots with the greatest after-tax return potential remaining by selling those first with the least after-tax return potential remaining In an investor's desire to raise cash. Enabling an investor to prioritize the sequencing of tax-lots to be sold in a process of raising cash, in a manner consistent with the goal of maximizing after-tax wealth accumulation.

The reason that a Serial Stream process, whereby if there are 100 tax-lots to be sequenced in a Job, has to identify the top ranking value of the After-Tax Annual Average Recommendation Advantage value, in combination with the lowest Existing Lot After-Tax IRR value, at least 99 times, is because, in the most simple example, without any Designations having been made, and without the realization and harvesting of losses in a Serial Stream process, (in a manner that could generate the selling of partial tax-lots, resulting in residual shares that require addition tax-lot analysis), after the 99^{th} iteration has assessed which of the last two tax-lots should be sold first, no further iterations are necessary to complete the optimization sequence ranking

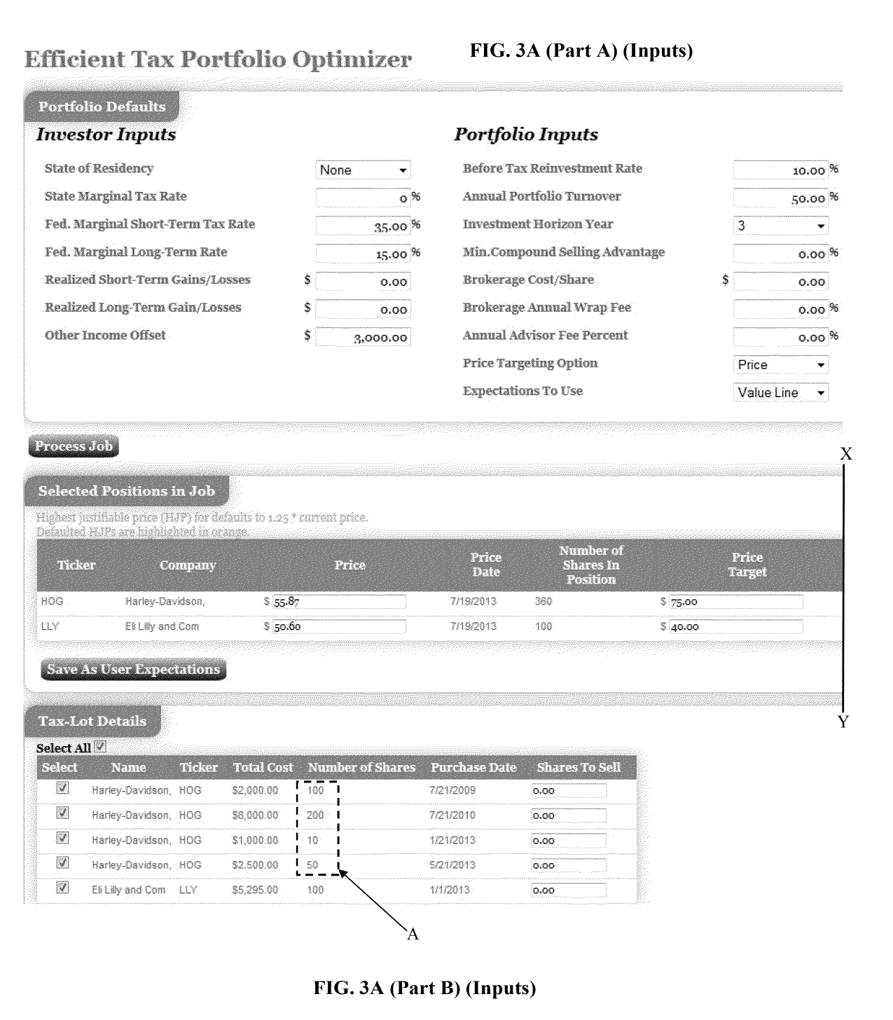

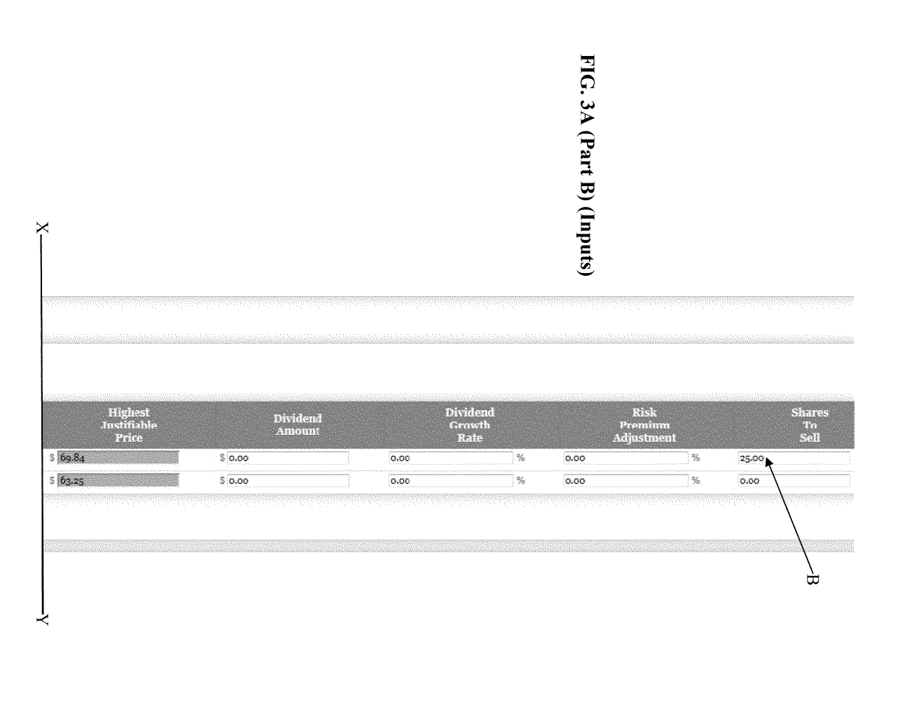

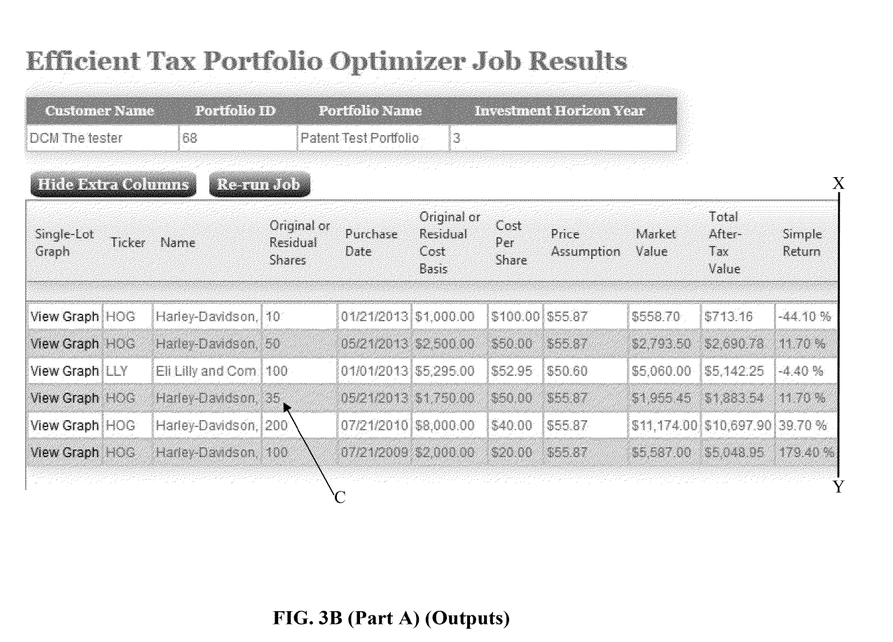

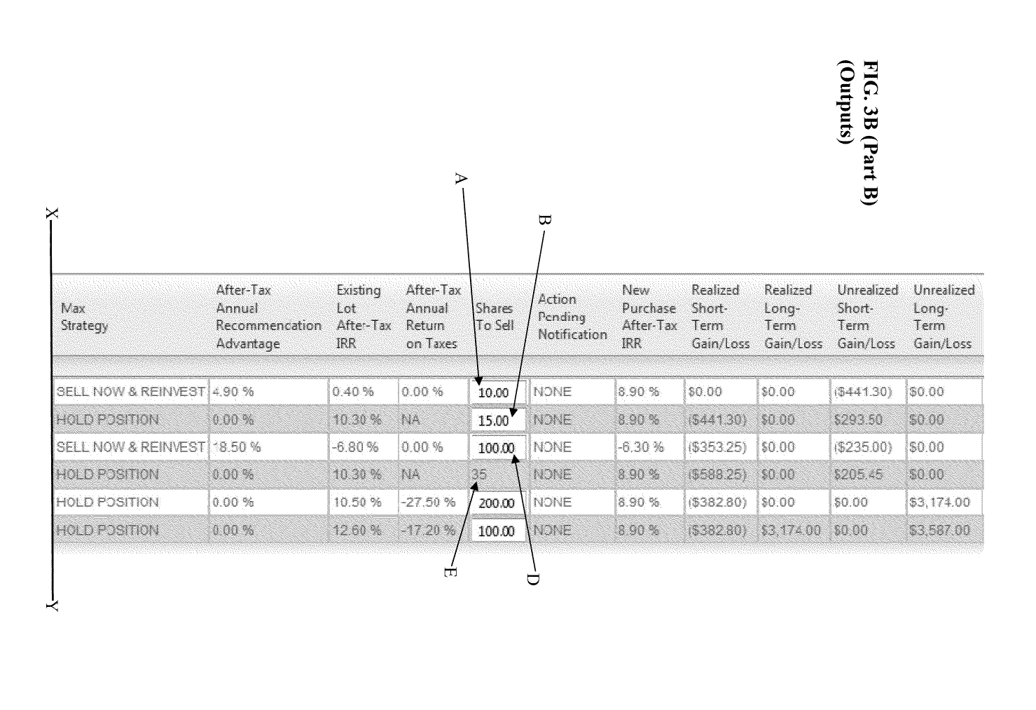

This process and method's inputs and results set are reflected in FIG. 3A (Inputs) and FIG. 3B (Outputs). In FIG. 3A (Inputs), the input page, the following Data Elements are identified:

A; Data Element “A” identifies the number of shares in each of four(4) individual tax-lots purchased on different dates, of Harley Davidson(HOG), for a total of 360 HOG shares in a total position, included in a Job of five(5) tax-lots, with an additional tax-lot of Ely Lilly(LLY) being included in the job.

B; Data Element “B” identifies the 25 shares of Harley Davidson that are being Designated to be sold out of the four tax-lot Harley Davidson position of 360 shares.

FIG. 3B (Outputs) displays the outputs from FIG. 3A (Inputs). The sequencing or ranking of whole or partial tax-lots to be sold in an ETPO process can be described via an explanation of the following Data Elements identified in the figure:

A; Data Element “A” in FIG. 3B Outputs, represents the first 10 shares, of a 25 share Designation to be sold. As opposed to the Jan. 21, 2013 purchase of HOG, which has a negative Simple Return, or an Unrealized Loss, the remaining HOG tax-lots are in profit territory, and their associated tax-burden, when coupled with their remaining return expectations, generate no After-Tax Annual Average Recommendation Advantage value. Therefore, given inputs, they are recommended to be Held. Only when the tax savings value of the loss of the Jan. 21, 2013 tax-lot is added to its remaining return potential, does it become a sale candidate. Therefore, when compared with selling any of the profitable HOG tax-lots, this one should be sold first. If there were more than one HOG tax-lot in a negative profit mode, then the one with the greatest value for After-Tax Annual Average Recommendation Advantage would be sold whole or in part, first, in satisfying any Position Designation. And as there are only ten(10) shares in that unprofitable tax-lot, all of them are recommended to be sold, with fifteen(15) shares remaining to be sold per the 25 Shares To Sell Position Designation.

B; Data Element “B” represents the remaining 15 Shares To Sell that would complete the 25 share Position Designation of Harley Davidson. The May 21, 2013 purchase of 50 shares of HOG contains a 10.3% Existing Tax-Lot After-Tax IRR, lower than the other HOG tax-lots, and therefore in the process of selling those tax-lots first, that would otherwise be a HOLD, with the least investment return potential remaining, shares in this tax-lot should be sold first. As the Jul. 21, 2010 purchase of HOG has a 10.5% Existing Tax-Lot After-Tax IRR, and the Jul. 21, 2009 purchase has a 12.6% one.

C; Data Element “D” of 35 shares of HOG purchased May 21, 2013 is the residual amount of shares left in that tax-lot after the 15 Designated shares are deducted from the original 50 shares purchased.

D; Data Element “D” is the first tax-lot to be sold in a ranking sequence, after the Position Designation shares have been implemented in the ranking process. The Ely Lily Jan. 1, 2013 purchase is an outright sell, with an 18.5% After-Tax Annual Average Recommendation Advantage. But is not ranked first, since the 25 Designated shares needed to be accommodated first.

E; Data Element “E” are the Residual Shares from the May 21, 2013 purchase of HOG, that were not included in the ranking prior, due to the Position Designation. And it is sold next since its Existing Tax-Lot After-Tax IRR value 10.3% is less than that of the Jul. 21, 2010 purchase of HOG at 10.5%, the next tax-lot to be sold, which itself is less than the value of 12.6% for the Jul. 21, 2009 purchase of HOG.

### Example 3

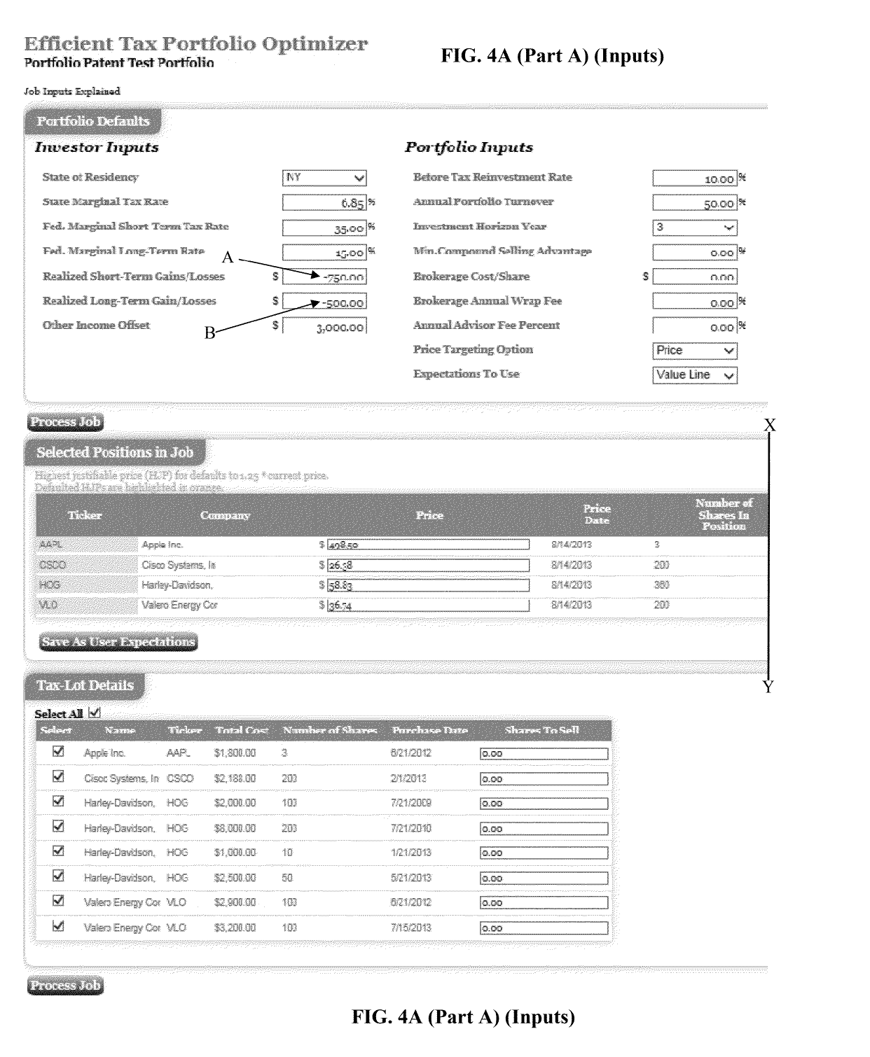

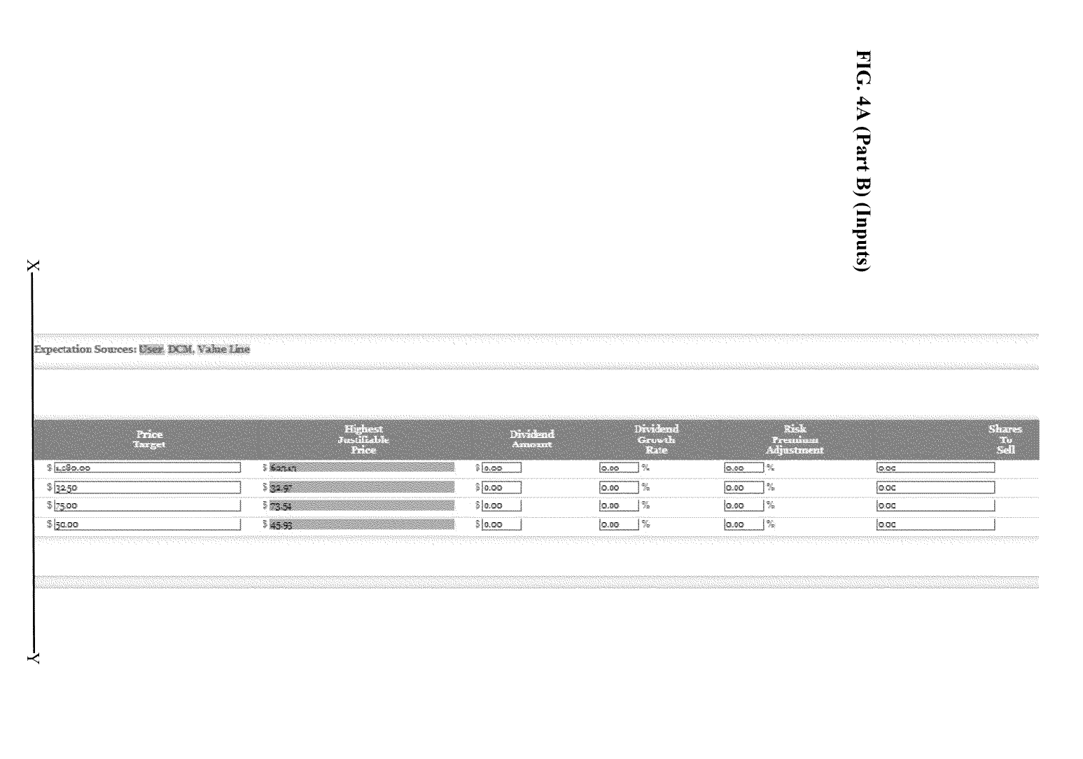

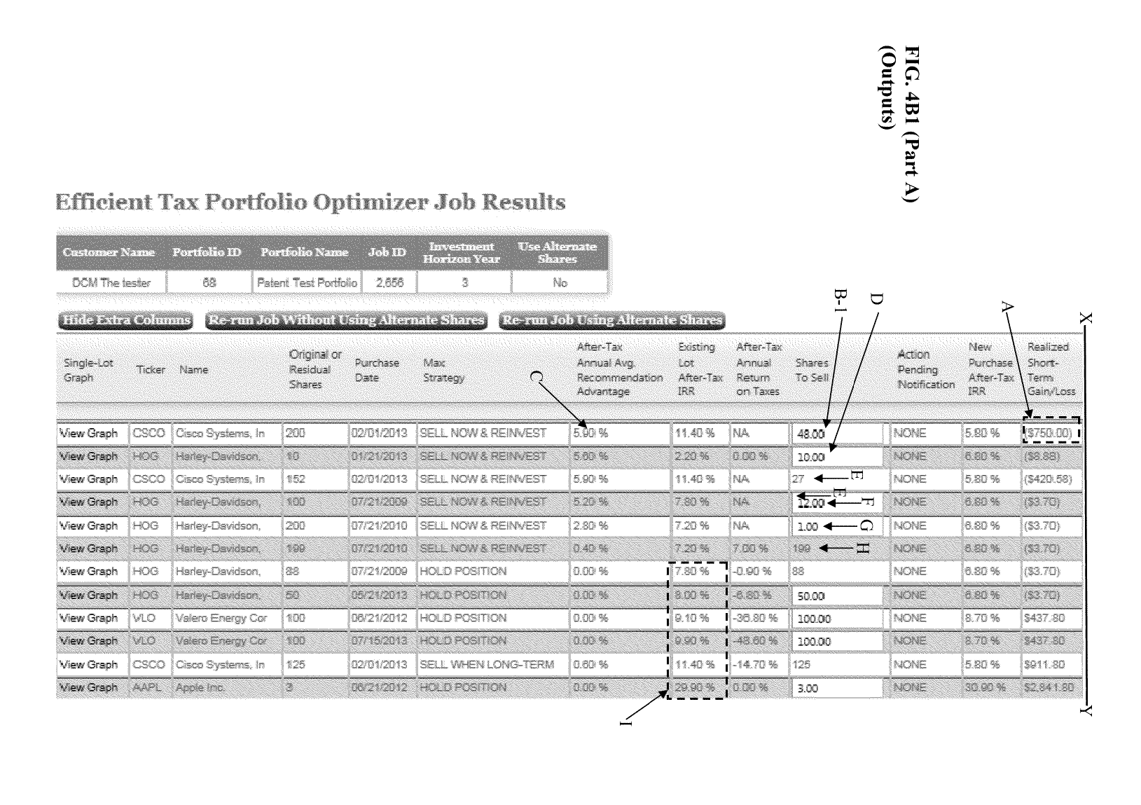

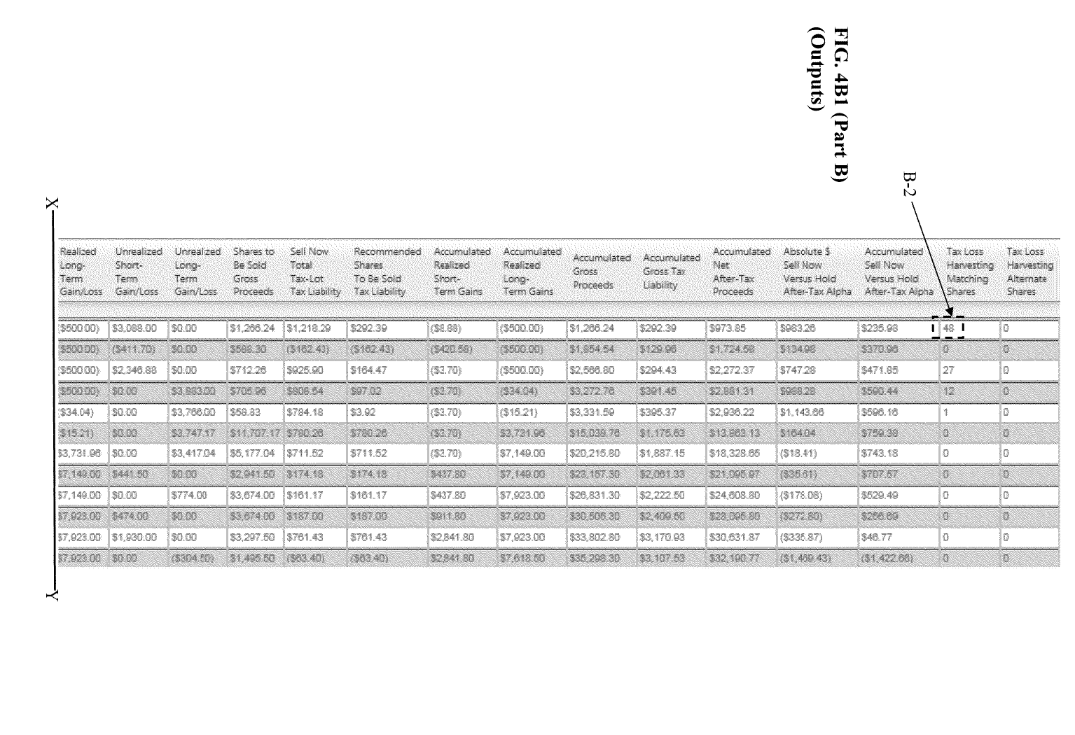

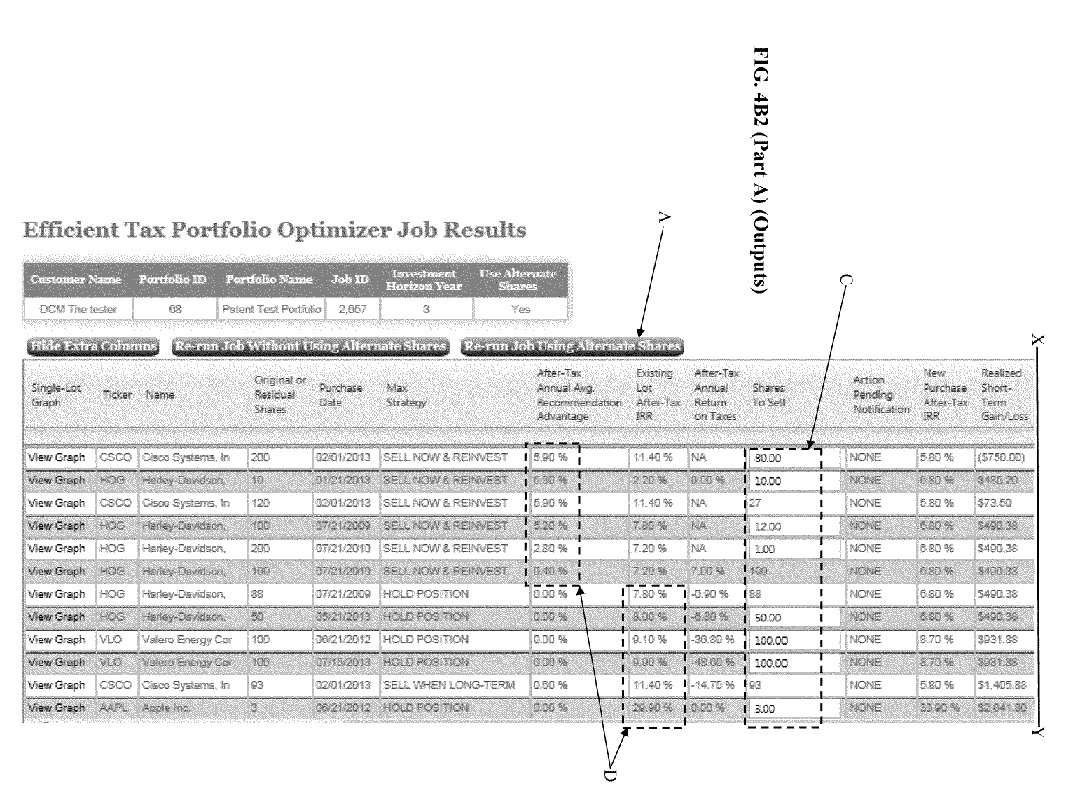

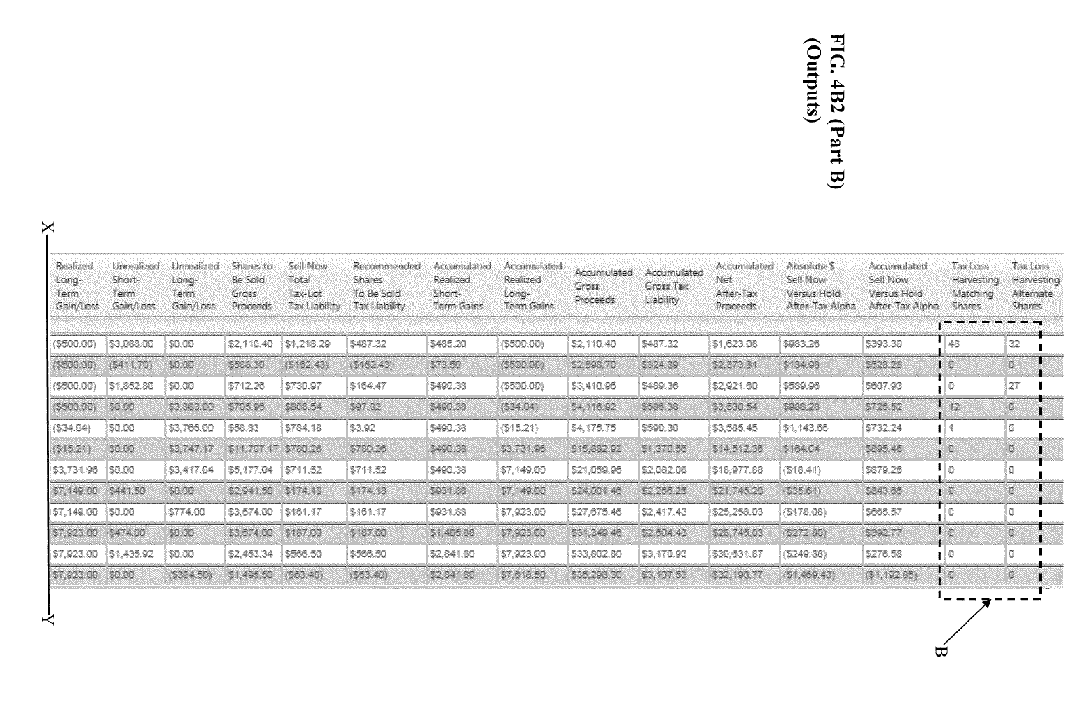

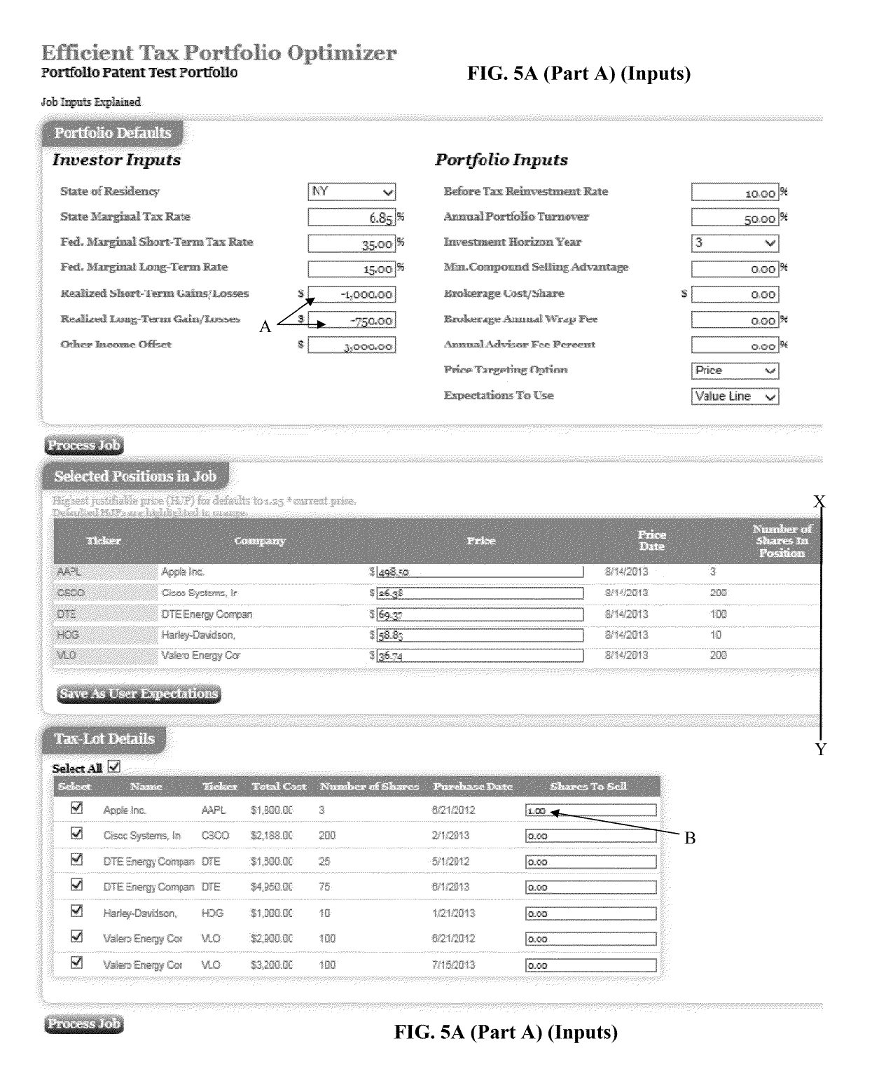

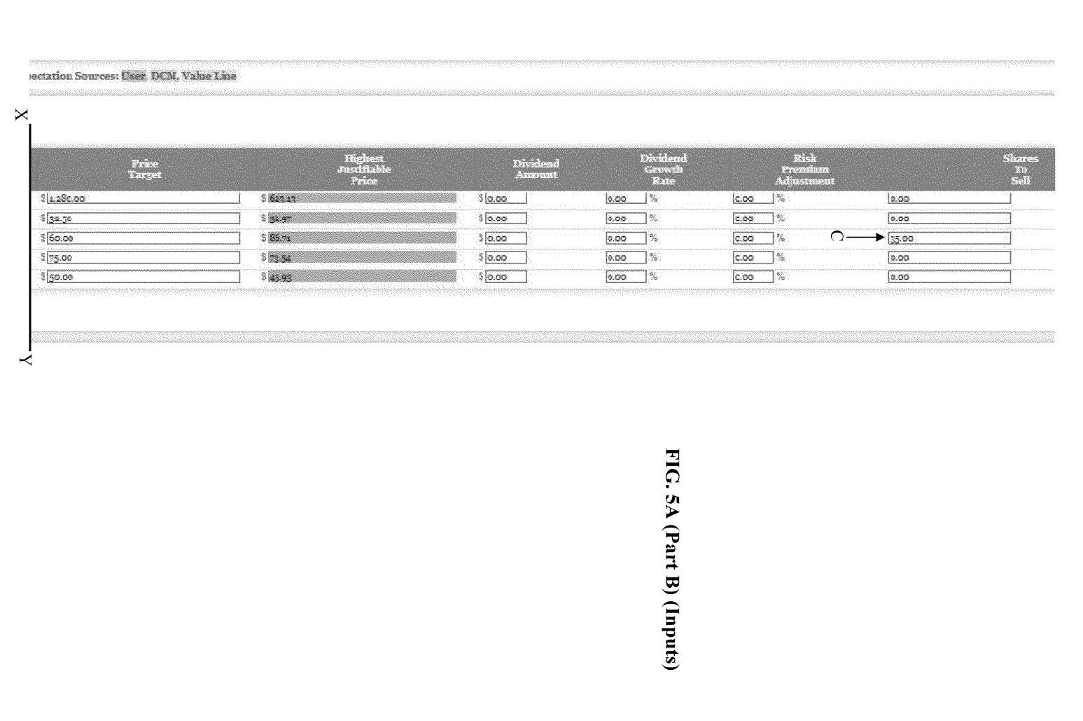

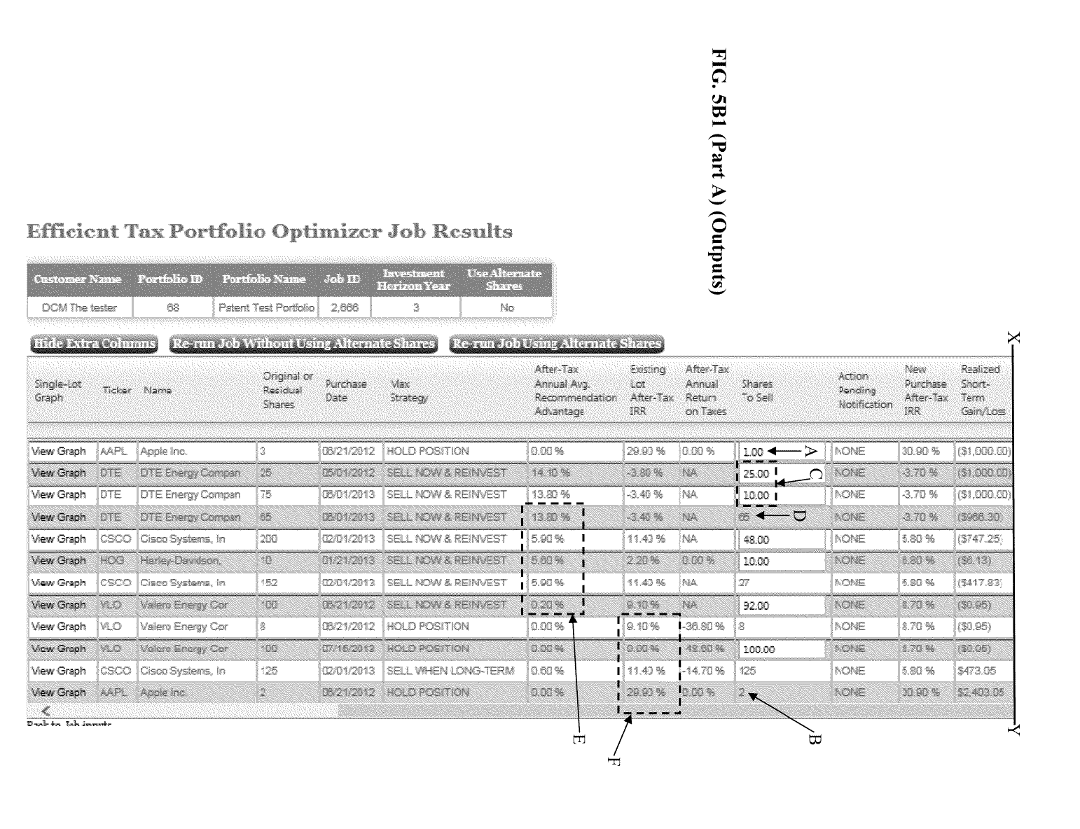

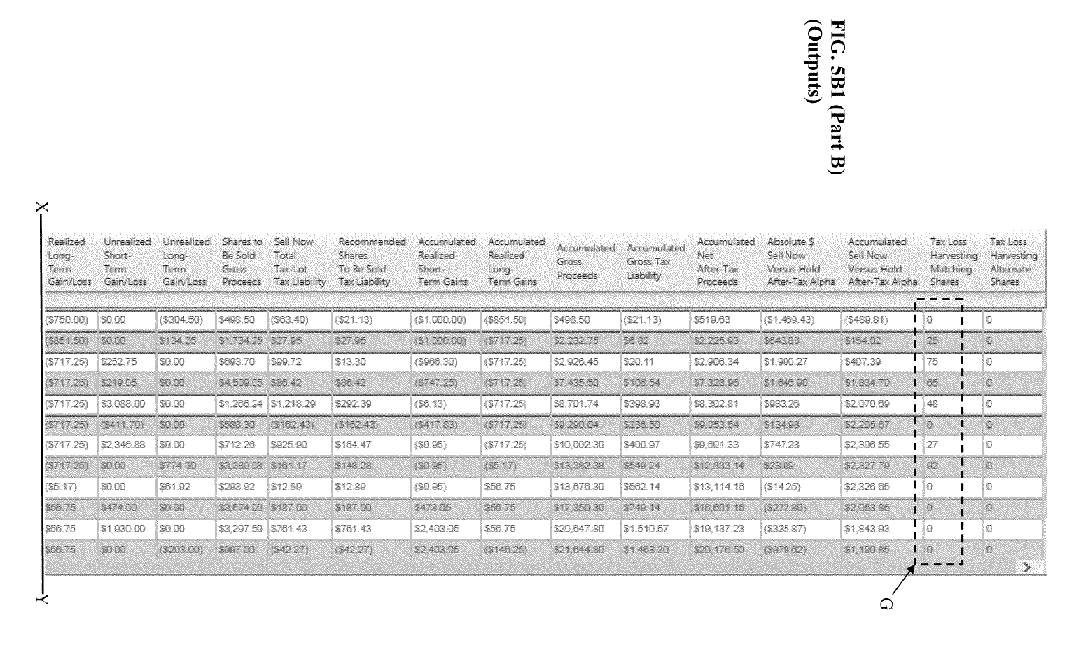

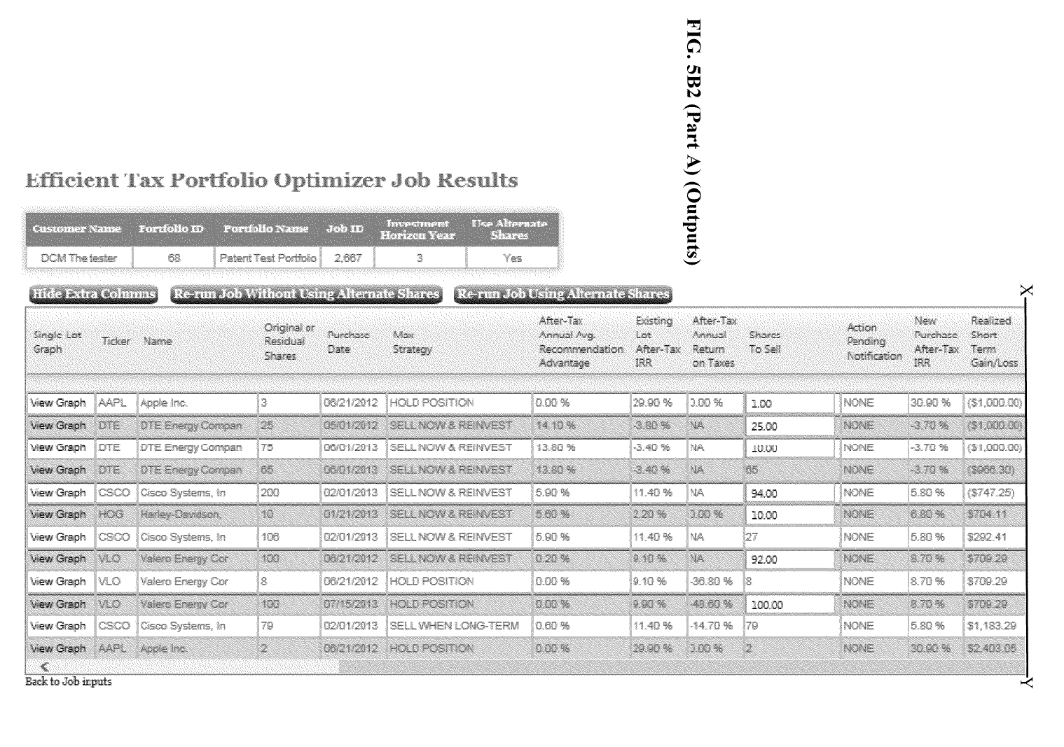

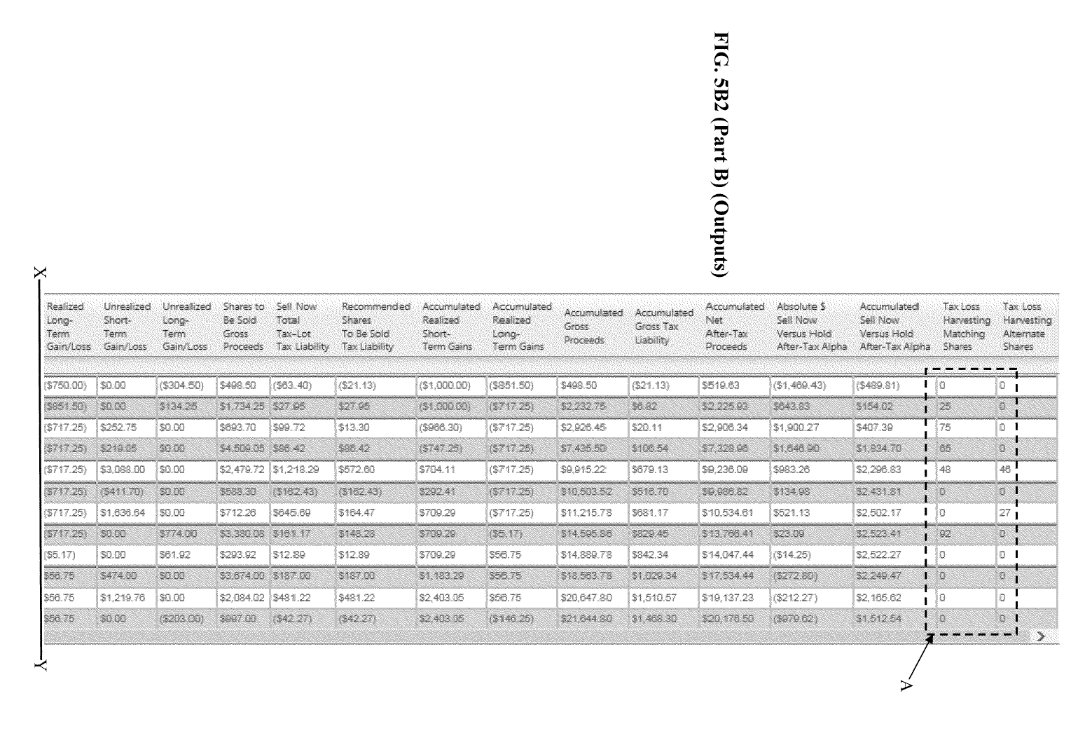

As part of the Serial Stream processes, losses, both short and long-term, may be realized, and harvested against whole or partial shares of profitable tax-lots, in a manner that either adds the greatest after-tax wealth over time, or gives up the least by doing so. An example of this process is reflected in FIG. 4A (Inputs) and FIG. 4B1 (Outputs). The input set displayed in FIG. 4A (Inputs) has Data Element “A” with a starting Realized Short-Term Gain/Loss value being a $750 loss, and the Data Element “B” having as a starting value for the Long-Term Gain/Loss input, a loss of $500.

These losses are harvested in an ETPO process, with the sequencing results displayed in FIG. 4B1 (Outputs), whereby only short-term losses are only offset against short-term gains, and long-term losses are only offset against long-term gains, with the following Data Elements identified and described:

A; Data Element “A” represents the starting Realized Short-Term Gain/Loss value of a minus value of ($750.00), available for harvesting.

B; Data Element “B”, is shown twice in this figure and example. Data Element “B-1” represents the number of Shares To Sell that the ETPO process method outputs as the optimal number of shares that, if sold, of a particular tax-lot, would generate a positive After-Tax Annual Average Recommendation Advantage value, if one exists due to a Hold decision being sub-optimal, and an Existing Tax-Lot After-Tax IRR value nonetheless.

In this example, 200 shares of Cisco(CSCO) were purchased on Jan. 1, 2013, for a total cost of $2,188.00, or $10.94 per share, making it still a short-term holding. With a current market price of $26.38, not shown, it is yielding an Unrealized Short-Term Gain of $3,088.00, or $15.44 in unrealized profit per share. The $750 in Short-Term Loss, if divided by the $15.44 profit per share, could be harvested against 48.575 shares, matching gains and losses, and resulting in no taxes due due to the sale. As ETPO doesn't recommend fractional Shares to Sell, we always round down to whole numbers. In this example, Data Element “B-2” indicates that 48 shares could be sold, given the $750 in Realized Short-Term Losses, avoiding any tax, as a result of Tax Loss Harvesting where Short-Term Losses can only be harvested against Short-Term Gains, and Long-Term Losses can only be offset and harvested against Long-Term Gains. If there exists no value other than Zero(0) for a value for Tax Loss Harvesting, “B-2”, then a positive Shares To Sell value “B-1” represents shares recommended to be sold, given a User's inputs, that could be sold, with the referenced outcomes, absent any Tax Loss Harvesting.

C; Data Element “C” identifies the After-Tax Annual Average Recommendation Advantage value of 5.9% associated with the extra after-tax return that could be achieved if, 48 shares were sold of the 200 Cisco shares purchased on Feb. 1, 2013, where the market value of those shares, since no taxes would be due as a result of Tax Loss Harvesting, could be reinvested to achieve higher after-tax wealth over three years. The reason these 48 shares are ranked at the top of the Sell optimization sequence, is because, given the starting losses, those losses could be used best against those 48 shares, garnering an extra 5.9% annual Alpha. Which is the highest value After-Tax Annual Average Recommendation Advantage among the ranking.

D; Data Element “D” identifies that next to using the otherwise available Short-Term Losses to offset Cisco gains, selling all 10 shares of Harley Davidson purchased on Jan. 21, 2013 for $100.00 per share, which at a Current Price of $58.83, suffers a loss, could be better sold, given its sub-par return potential, by coupling the extra value by investing in something with more upside, in addition to the tax-savings potential by realizing this tax-lot's unrealized short-term losses, and utilizing them against tax-lots with short-term gains, and avoiding high short-term taxes.

E; Data Element “E” indicates that as a result of the previous recommended sale of the 10 Harley Davidson shares at a loss, generating an additional amount of Realized Short-Term Losses, that there would again be losses available to add the 5.9% After-Tax Annual Average Recommendation Advantage against the after-tax proceeds of selling an additional 27 Cisco shares. Notice that absent losses to offset Cisco gains, that no more Cisco shares are identified as eligible to sell, and the remaining shares are ranked near the bottom therefore in the optimization tax-lot selling sequence.

F; Data Element “F” represents that the next best number of shares to sell in sequence would be to sell 12 share of the 100 shares of Harley Davidson purchased on Jul. 21, 2009 at $20 per share. The number of shares, with a profit, in this case at $38.83 per share, with a current market price of $58.83, whose gains could be fully offset by the $500 Long-Term Losses available for Tax Loss Harvesting, is 12.876. Rounding down, we have 12 shares of Harley Davidson that could be sold, without any taxes being paid, with the proceeds being reinvested at higher rates of returns than is remaining with Harley at these prices. Selling these shares would generate a 5.2% After-Tax Annual Average Recommendation Advantage, compared with the higher 5.9% value from the shares indicated to be sold prior, utilizing losses, and higher than the one succeeding it at 2.8%, only achieved because of the losses being available.

G; Data Element “G” represents that the next best number of Shares To Sell in sequence, out of the remaining original or residual shares in remaining tax-lots, is just 1 share of Harley Davidson. Of the 200 purchased on Jul. 21, 2010. Since there is only enough remaining Realized Long-Term Losses, at $34.04, to harvest one share of HOG with a profit of $18.83 per share. Not enough to have harvested a 13^{th} share of the HOG shares purchased on Jul. 21, 2009 with an unrealized $38.83 profit, but enough to harvest one share with a profit of $18.83. However not for 2 shares, that would require $37.66 of Long-Term Realized Losses available for harvesting.

H; Data Element “H” identifies that the remaining 199 long-term shares of the Harley Davidson shares purchased on Jul. 21, 2010 that would not be sold as a result of utilizing losses, that would still be justified as a Sell Now & Reinvest candidate since even without harvesting losses, it is forecasted to capture an extra 0.4% After-Tax Annual Average Recommendation Advantage.

I; Data Element Set “I” highlights that the remaining tax-lots within the example portfolio that have not already been included in the Shares To Sell optimization process, would not add value by selling, and therefore instead have a Max Strategy of either “Hold Position” or “Sell When Long-Term”. However they are then ranked in ascending order keeping those first with the least remaining Existing Tax-Lot After-Tax IRR. Resulting in a portfolio keeping those tax-lots with the highest after-tax return potential remaining

### Example 4

Normally Short-Term Capital Losses must be harvested and applied against Short-Term Capital Gains, and Long-Term Capital Losses must be harvested or applied against Long-Term Gains. However the tax law allows that if at the end of a tax year, a taxpayer has net residual long-term losses, after offsetting all of the year's long-term losses against gains, and by adding any long-term capital loss carry-forward, then those losses can be used to offset likewise net residual short-term gains. And vice versa. Residual short-term losses can be used to avoid taxes on net realized residual long-term gains. Doing so would under-utilize the potential value of the short-term loss by only reducing profit that would be taxed at the lower long-term tax rate when it could otherwise be used to reduce a profit that would be taxed at the higher short-term rate. While offsetting a long-term loss against a short-term gain adds value otherwise to a loss. FIG. 4B2 (Outputs) is another version of outputs given the inputs displayed in FIG. 4A (Inputs), but with the enhanced analysis of how best to harvest losses against tax-lots utilizing Alternate realized losses as opposed to Matched ones.

A; Data Element, or Reference “A” in FIG. 4B2 (Outputs), is a tab that must be “Clicked” if after a ETPO Job is run, if the User wishes to “Re-run Job Using Alternate Shares”. In which case a different set of outputs result.

B; Data Element or Data Set “B” displays a new set of Tax Loss Harvesting shares to be included in Shares to Sell, as a result of the User wishing to add the Alternate Share inclusion feature, by clicking the Re-run Job Using Alternate Shares button, hopefully just at the very end of the year.

C; Data Set “C” Recognizes the inclusion of the Alternate Losses Tax Loss Harvesting feature, and its impact on the number of Shares To Sell, and therefore the amount of gains and losses realized, and then how they are applied. You will notice that the combined number of Matched and Alternate Tax Loss Harvesting shares are included in the “Shares To Sell”. That all explains the difference in the sequencing of the tax-lots to sell, and the number of Shares To Sell.

D; Data Set “D” represents a full ETPO optimization sequencing process without any individual tax-lot or position sale designations. Showing that tax-lots are sold in sequence selling those shares that would add the greatest After-Tax Annual Average Recommendation Advantage first by doing so, and then converting to selling those with the least Existing Tax-Lot After-Tax IRR. It may appear that the second item has a lower After-Tax Annual Average Recommendation Advantage than the succeeding one, but the succeeding one wouldn't have its higher value unless the losses realized from the second item were available to harvest the 27 shares of the third tax-lot in sequence. A short-term gain insulated from taxes by using long-term Alternate losses. We will alert Users that any sales beyond the row indicated by an Alternate sale, could eliminate any Residual Short or Long-Term losses, and could expose the investor to more taxes than otherwise anticipated.

### Example 5

Once all individual Tax-Lot Designations, and Position Designations have been made, and processed, updating the realized gain and loss values along the way, all remaining tax-lots, and or residual shares remaining, will be processed in the general optimization Serial Stream. First, of course, using the highest After-Tax Annual Average Recommendation Advantage value as the ranking driver. Then switching to the lowest Existing Tax-Lot After-Tax IRR, once those tax-lots with an After-Tax Annual Recommendation Advantage value have been identified and exhausted.

It is possible that once all the After-Tax Annual Average Recommendation Advantage tax-lots have initially been recommended for sale, and the lowest Existing Tax-Lot After-Tax IRR value is being used as the sequencing driver, that a loss realized in the latter process, now available for harvesting, could re-generate one or more tax-lots that if sold, would generate an After-Tax Annual Recommendation Advantage on a particular yet to be optimized tax-lot, that the optimization process didn't before identify as the highest value user of the losses. But lower in the ranking, it then becomes the optimal user of losses as a Sell Now & Reinvest recommendation. With the optimization process then reverting again back to using the Existing Tax-Lot After-Tax IRR, when appropriate.

FIG. 5A (Inputs), FIG. 5B1 (Outputs) and FIG. 5B2 (Outputs) reflect a set of inputs and outputs that include all of the features heretofore described, in an individual Job. In these figures we reference and describe additional aspects that may not have been described prior.

FIG. 5A (Inputs), has a few data inputs to make special note of;

A; Data Set “A” illustrates that we, in this example, start a Job with loss values for the Realized Short and Long-Term Gain/Loss values of a minus $1,000 and $750 respectively. This will immediately impact Tax Loss Harvesting results.

B; Data Element “B” represents a Tax Lot Designation whereby an investor, in this example, has decided, that regardless of anything else, he or she is going to sell 1 share of the 3 shares of Apple they own. All such Designations are ranked at the top of the optimization ranking sequence so that the consequences on the Realized Gain/Loss values can be updated with the impacts of such Designated sales, and to calculate and accumulate other outputs that are important to the investor, such as Accumulated After-Tax Proceeds.

C; Data Element “C” represents the Designation of 35 shares to be sold from a Position of two tax-lots, with a combined share count of 100. ETPO will sequence the Designated selling of 35 shares such that it will sell shares first from that tax-lot, when the same Realized Gain/Loss values are inputted into all tax-lots within a position, that is identified as the one with either the highest After-Tax Annual Average Recommendation Advantage, if any exists. Updating in a reiterative fashion, the Realized Gain and Loss values, continuing to fully satisfy the Designated Shares to Sell requirement, by selling those tax-lots with the highest After-Tax Annual Average Recommendation Advantage. And if not enough shares have been identified to fully satisfy the Position Designation, then to continue the reiterative process of sequencing which tax-lots to sell and in which order, by selling those first with the least Existing Tax-Lot After-Tax IRR. Once all Position Designation shares have been included in the Shares To Sell ranking, any remaining full or partial tax-lots from that position, shall be considered either Original or Residual shares, and will be further evaluated for ranking purposes through the remainder of the ETPO Serial Stream optimization process.

FIG. 5B1 (Outputs) is the non-Alternate Results Set from inputs from FIG. 5A (Inputs), as it reflects both the individual Apple tax-lot sell Designation of 1 share, and the 35 share DTE Position Designation. With the following Efficient Tax Portfolio Optimizer outputs highlighted and explained;

A; Data Element “A” reflects the User's decision to sell 1 share of Apple out of the portfolio's only Apple tax-lot of 3 shares purchased on Jun. 21, 2012. With a current price of $498.50, and with a cost of $600.00 per share, there exists a $304.50 unrealized loss imbedded in the investment. Even though the recommendation is “Hold Position”, and even though the Existing Tax-Lot After-Tax IRR is 29.9%, this single 1 share is ranked first, because it was Designated to be so. Requiring that the Realized Long-Term Loss value to be updated with a realization of an additional $101.50 long-term loss.

B; Data Element “B” represents the 2 shares of Apple that weren't Designated to be sold, that are placed at the bottom of the ranking since it is both a Hold Position tax-lot, (and therefore with a value of 0% for its After-Tax Annual Average Recommendation Advantage), and it has the highest calculated Existing Tax-Lot After-Tax IRR value, ranking it last to be sold.

C; Data Set “C” reflects that the 35 DTE Position Designation should be first satisfied with the 25 shares purchased on May 1, 2012 with a Sell Now & Reinvest After-Tax Annual Average Recommendation Advantage value of 14.1% with a cost of $64.00 per share. The remaining 10 shares Designated are recommended to be sold from the 75 shares purchased on Jun. 1, 2013 at a cost of $66.00 per share. With a current market price of $69.37, ETPO recommends selling first the Long-Term tax-lot with an 8.4% unrealized gain, before it recommends selling a Short-Term tax-lot with a little lower 5.1% return. Because the higher short-term tax rate on the lower 5.1% gain would be more per share than the long-term tax on the 8.4% gain.

D; Data Element “D” indicates that the remaining 65 shares of DTE so far not included in previous Shares To Sell results, are next in line to be sold, since they have the highest After-Tax Annual Average Recommendation Advantage than all of the remaining tax-lots and shares not yet included in Shares To Sell.

E; Data Set “E” displays the sequence of Sell Now & Reinvest candidates recommended to be sold in sequence from the greatest After-Tax Annual Average Recommendation Advantage, to the least.

F; Data Element “F” illustrates that once all the tax-lots, assuming up-to-date Realized Gain/Loss values, have been ranked using the After-Tax Annual Average Recommendation Advantage, that selling continues in sequence selling those first with the least Existing Tax-Lot After-Tax IRR.

G; Data Set “G” displays the number of shares recommended to be sold, and in what sequence, that engages in Tax Loss Harvesting in a manner that applies Matching gain and loss values in a sequence that utilizes available losses first when it will do the most good by generating the highest After-Tax Annual Average Recommendation Advantage by doing so.

FIG. 5B2 (Outputs) simply adds the illustration of the impacts of including any Alternate realized losses either of offsetting short-term losses against long-term gains, or long-term losses against short-term gains, on the Shares To Sell values, and optimization ranking As referenced in Data Set “A”.

It will be understood that the foregoing illustrative embodiments are implemented as computerized systems and methods, which may comprise, for example, one or more processors, at least one non-transitory computer-readable medium, software, and a user interface. The user interface (e.g., which may comprise a graphical user interface (GUI) and/or a browser) may be used for entering the user-specified information (e.g., designations, financial data, etc.) to be processed, for displaying results of the processing, and for other purposes. In some embodiments, the system and method may be implemented as a web-based system. In some implementations, the underlying engine for carrying out the ETPO processing (e.g., reiterative processing) may be implemented using a commercial spreadsheet application and/or dedicated application program. The one or more processors includes hardware operable for executing code (e.g., which may include executing a spreadsheet executable) for performing the analysis, and the one or more processors may be implemented in one or more personal computers and/or workstations, and may be implemented as server(s) and/or client(s), and may be configured for communication over an intranet and/or the Internet. The at least one computer-readable storage medium may include a variety of information about investment alternatives, performance expectations for these investment alternatives, client data, and other information.

It will be understood from the foregoing, that myriad variations and additional or alternative embodiments may be implemented without departing from the scope of the present disclosure. The present invention has been illustrated and described with respect to specific embodiments thereof, which embodiments are merely illustrative of the principles of some embodiments of the invention and are not intended to be exclusive or otherwise limiting embodiments. Accordingly, although the above description of illustrative embodiments of the present invention, as well as various illustrative modifications and features thereof, provides many specificities, these enabling details should not be construed as limiting the scope of the invention, and it will be readily understood by those persons skilled in the art that the present invention is susceptible to many modifications, adaptations, variations, omissions, additions, and equivalent implementations without departing from this scope and without diminishing its attendant advantages. For instance, except to the extent necessary or inherent in the processes themselves, no particular order to steps or stages of methods or processes described in this disclosure, including the figures, is implied. In many cases the order of process steps may be varied, and various illustrative steps may be combined, altered, or omitted, without changing the purpose, effect or import of the methods described. Similarly, the structure and/or function of a component may be combined into a single component or divided among two or more components. It is further noted that the terms and expressions have been used as terms of description and not terms of limitation. There is no intention to use the terms or expressions to exclude any equivalents of features shown and described or portions thereof. Additionally, the present invention may be practiced without necessarily providing one or more of the advantages described herein or otherwise understood in view of the disclosure and/or that may be realized in some embodiments thereof. It is therefore intended that the present invention is not limited to the disclosed embodiments but should be defined in accordance with claims that are based on the present disclosure, as such claims may be presented herein and/or in any patent applications claiming priority to, based on, and/or corresponding to the present disclosure.

What is claimed is:

1. A method of facilitating optimization of after-tax wealth across a portfolio of taxable equity security tax-lots over at least one investment time period, said method being implemented by a computer system comprising at least one processor operable in executing program code stored on at least one non-transitory computer-readable medium to cause the computer system to perform the method comprising:
said at least one processor receiving tax data, data representing the tax-lots in said portfolio, equity security expectation data, and realized gain and loss data;
said at least one processor performing first reiterative processing based on said tax, tax lot, equity security expectation, and realized gain and loss data to determine a sequence for potentially selling a plurality of said tax-lots such that doing so would generate the greatest excess after-tax returns relative to holding the respective tax-lots over the at least one investment time period, wherein the reiterative processing comprises updating the realized gain and loss data following the determination of each tax lot in the sequence for determining the next tax lot in the sequence, wherein the recommended tax-lot selling sequence is organized according to successively descending respective after-tax returns relative to holding the respective tax lot; and
following said first reiterative processing, said at least one processor performing second reiterative processing to determine a sequence for potentially selling a plurality of residual ones of said tax-lots such that doing so would give up the least opportunity cost relative to holding the respective tax-lots over the at least one investment time period, wherein the reiterative processing comprises updating the realized gain and loss data following the determination of each tax lot in the sequence for determining the next tax lot in the sequence, wherein the recommended tax-lot selling sequence is organized according to successively ascending respective return potential remaining over the at least one investment period relative to holding the respective tax lot.

2. The method according to claim 1, further comprising, prior to said first reiterative processing:
said at least one processor receiving data designating sale shares of a position comprising a plurality of tax lots;
said at least one processor performing third reiterative processing based on said tax, tax lot, equity security expectation, and realized gain and loss data to determine a sequence for potentially selling a plurality of tax-lots of said position such that doing so would generate the greatest excess after-tax returns relative to holding the respective tax-lots of said position over the at least one investment time period, wherein the reiterative processing comprises updating the realized gain and loss data following the determination of each tax lot in the sequence for determining the next tax lot in the sequence, wherein the recommended tax-lot selling sequence is organized according to successively descending respective after-tax returns relative to holding the respective tax lot of the position; and
following said third reiterative processing, said at least one processor performing fourth reiterative processing to determine a sequence for potentially selling a plurality of residual ones of said multiple tax-lots of said position designated for sale such that doing so would give up the least opportunity cost relative to holding the respective tax-lots of said position over the at least one investment time period, wherein the reiterative processing comprises updating the realized gain and loss data following the determination of each tax lot of said position in the sequence for determining the next tax lot of said position in the sequence, wherein the recommended tax-lot selling sequence for said position designated for sale is organized according to successively ascending respective return potential remaining over the at least one investment period relative to holding the respective tax lot.

3. The method according to claim 2, further comprising, prior to said third reiterative processing:
said at least one processor receiving data designating sale of at least one share of each of one or more respective individual tax lots corresponding to one or more respective equities that are not of a common position; and
said at least one processor updating the realized gain and loss data to reflect the potential sale of the designated at least one share of each of the individual tax lots corresponding to one or more respective equities that are not of a common position.

4. The method according to claim 1, further comprising, prior to said first reiterative processing:
said at least one processor receiving data designating sale of at least one share of each of one or more respective individual tax lots corresponding to one or more respective equities that are not of a common position; and
said at least one processor updating the realized gain and loss data to reflect the potential sale of the designated at least one share of each of the individual tax lots corresponding to one or more respective equities that are not of a common position.

5. The method according to claim 1, wherein at least one of the first and second reiterative processing comprises tax-loss harvesting analysis.

6. The method according to claim 1, wherein at least the first reiterative processing comprises for each iteration tax-lot strategy path analysis of each residual tax lot to identify a maximum strategy.

7. The method according to claim 1, further comprising the at least one processor receiving highest justifiable price data for the tax lots.

8. At least one non-transitory computer-readable medium comprising code that, when executed by at least one processor, is operative to cause that at least one processor execute the method according to claim 1.

9. A system comprising at least one processor and at least one non-transitory computer-readable medium, the system being operable to execute the method according to claim 1.
